(19) United States
(12) Patent Application Publication
(10) Pub. No.: US 2024/0242883 A1
(43) Pub. Date: Jul. 18, 2024

(54) METHOD FOR MANUFACTURING COIL COMPONENT

(71) Applicant: TDK Corporation, Tokyo (JP)

(72) Inventors: Yuya ISHIMA, Tokyo (JP); Kenji KOMORITA, Tokyo (JP); Shingo HATTORI, Tokyo (JP); Yoji TOZAWA, Tokyo (JP); Masaki TAKAHASHI, Tokyo (JP); Hidenobu UMEDA, Tokyo (JP); Yusuke NAGAI, Tokyo (JP); Akihiko OIDE, Tokyo (JP)

(73) Assignee: TDK Corporation, Tokyo (JP)

(21) Appl. No.: 18/410,188

(22) Filed: Jan. 11, 2024

(30) Foreign Application Priority Data
Jan. 13, 2023 (JP) 2023-004030

(51) Int. Cl. H01F 41/076; H01F 41/12

(52) U.S. Cl. CPC H01F 41/076; H01F 41/122

(57) ABSTRACT

A method for manufacturing a coil component including an element body, and a coil disposed inside the element body and including a first coil conductor and a second coil conductor having different shapes, the method comprises: applying a first photosensitive conductive paste on a substrate and exposing the first photosensitive conductive paste to light with a pattern corresponding to the first coil conductor to form a first curing pattern; after the forming of the first curing pattern, applying a second photosensitive conductive paste on the first photosensitive conductive paste and exposing the second photosensitive conductive paste to light with a pattern corresponding to the second coil conductor to form a second curing pattern; after the forming of the second curing pattern, developing portions of the first photosensitive conductive paste and the second photosensitive conductive paste that were not exposed; and after the developing, adding an insulating material on the substrate.

### TECHNICAL FIELD

The present disclosure relates to a method for manufacturing a coil component. This application is based upon and claims the benefit of priority from Japanese Patent Application No. 2023-004030, filed on Jan. 13, 2023, the entire contents of which are incorporated herein by reference.

### BACKGROUND

Manufacturing methods such as those disclosed in WO 2016/006542 A1 (Patent Literature 1) and Japanese Unexamined Patent Publication No. 2019-186525 (Patent Literature 2) are known as methods for manufacturing a coil component including an element body and a coil disposed inside the element body. The manufacturing method disclosed in Patent Literature 1 includes a step of forming a conductor layer by photolithography, and a step of forming an insulating paste layer in which an opening is provided by photolithography. The manufacturing method disclosed in Patent Literature 2 includes a step of forming a conductive paste layer on a substrate using photolithography, a step of forming a glass paste layer so as to cover the conductive paste layer using photolithography, and a step of forming a retaining layer that can be removed after firing in an area on the substrate where the conductive paste layer and the glass paste layer are absent.

### SUMMARY

In the invention disclosed in Patent Literature 1, the insulating paste is required to be thick in order to fill the step in the forming surface when forming a pattern of the insulating paste layer on a pattern of the conductive layer. In the manufacturing method disclosed in Patent Literature 2, although providing a retaining layer keeps the forming surface flat, the number of steps is increased.

It is an object of the present disclosure to provide a method for manufacturing a coil component that is capable of suppressing an increase in the number of steps while keeping a forming surface flat.

A method for manufacturing a coil component according to a first aspect of the present disclosure is a method for manufacturing a coil component including an element body, and a coil disposed inside the element body and including a first coil conductor and a second coil conductor having different shapes, the method including: applying a first photosensitive conductive paste on a substrate and exposing the first photosensitive conductive paste to light with a pattern corresponding to the first coil conductor to form a first curing pattern; after the forming of the first curing pattern, applying a second photosensitive conductive paste on the first photosensitive conductive paste and exposing the second photosensitive conductive paste to light with a pattern corresponding to the second coil conductor to form a second curing pattern; after the forming of the second curing pattern, developing portions of the first photosensitive conductive paste and the second photosensitive conductive paste that were not exposed; and after the developing, adding an insulating material on the substrate.

In the method for manufacturing a coil component according to the first aspect, the first photosensitive conductive paste and the second photosensitive conductive paste are exposed to light to form the first curing pattern and the second curing pattern, and then the portions of the first photosensitive conductive paste and the second photosensitive conductive paste that were not exposed are developed together, so that an increase in the number of steps can be suppressed while the forming surface on which the second photosensitive conductive paste is formed can be kept flat.

In the forming of the first curing pattern, application and light exposure of the first photosensitive conductive paste may be repeated to form the first curing pattern, and in the developing, the portions of a plurality of the first photosensitive conductive pastes and the second photosensitive conductive paste that were not exposed may be developed. In this case, the first curing pattern can be formed with a high aspect ratio, while the increase in the number of steps can be suppressed and the forming surfaces on which the second and subsequent layers of the first photosensitive conductive paste and the second photosensitive conductive paste are formed can be kept flat.

The method for manufacturing a coil component according to the first aspect may further include forming an insulating layer on the first curing pattern between the forming of the first curing pattern and the forming of the second curing pattern. Even in this case in which the insulating layer is disposed between the first curing pattern and the second curing pattern, the increase in the number of steps can be suppressed while the forming surfaces on which the insulating layer and the second photosensitive conductive paste are formed can be kept flat.

The method for manufacturing a coil component according to the first aspect may further include firing the first curing pattern and the second curing pattern between the developing and the adding. In this case, a material having low thermal resistance can be used as the insulating material to be added.

The method for manufacturing a coil component according to the first aspect may further include firing the first curing pattern, the second curing pattern, and the insulating material after the adding. In this case, a material that exhibits magnetism by firing can be used as the insulating material to be added.

The method for manufacturing a coil component according to the first aspect may further include forming, on the substrate, a conductive paste to be a terminal electrode to be connected to the coil, before the developing. In this case, the terminal electrode can be formed together with the coil. The number of steps can be reduced since the need to form the terminal electrode after forming the coil is eliminated.

A method for manufacturing a coil component according to a second aspect of the present disclosure is a method for manufacturing a coil component including an element body, and a coil disposed inside the element body and including a coil conductor, the method including: applying a photosensitive conductive paste on a substrate and exposing the photosensitive conductive paste to light with a pattern corresponding to the coil conductor to form a curing pattern; after the forming of the curing pattern, developing a portion of the photosensitive conductive paste that was not exposed; and after the developing, adding an insulating material on the substrate, wherein in the forming of the curing pattern, application and light exposure of the photosensitive conductive paste are repeated to form the curing pattern, and wherein in the developing, a plurality of the portions of a plurality of the photosensitive conductive pastes that were not exposed are developed.

In the method for manufacturing a coil component according to the second aspect, the application and light exposure of the photosensitive conductive paste are repeated to form the curing pattern, and then the portions of the photosensitive conductive pastes that were not exposed are developed together, so that the curing pattern can be formed with a high aspect ratio, while the increase in the number of steps can be suppressed and the forming surfaces on which the second and subsequent layers of the photosensitive conductive paste are formed can be kept flat.

A method for manufacturing a coil component according to a third aspect of the present disclosure is a method for manufacturing a coil component including an element body, and a coil disposed inside the element body and including a coil conductor, the method including: applying a photosensitive conductive paste on a substrate and exposing the photosensitive conductive paste to light with a pattern corresponding to the coil conductor to form a curing pattern; after the forming of the curing pattern, forming an insulating layer on the curing pattern; after the forming of the insulating layer, developing a portion of the photosensitive conductive paste that was not exposed; and after the developing, adding an insulating material on the substrate.

In the method for manufacturing a coil component according to the third aspect, the photosensitive conductive paste is exposed to light and the curing pattern is formed, and then the insulating layer is formed on the curing pattern before the portion of the photosensitive conductive paste that was not exposed is developed, so that the increase in the number of steps can be suppressed while the forming surface on which the insulating layer is formed can be kept flat.

### BRIEF DESCRIPTION OF THE DRAWINGS

FIG. 1 is a perspective view of a coil component according to a first embodiment.

FIG. 2 is a diagram illustrating a cross-sectional configuration of the coil component of FIG. 1.

FIG. 3 is a flowchart illustrating a method for manufacturing the coil component of FIG. 1.

FIGS. 4A, 4B, 4C and 4D are diagrams illustrating a manufacturing step of the coil component of FIG. 1.

FIGS. 5A, 5B, 5C and 5D are diagrams illustrating a manufacturing step of the coil component of FIG. 1.

FIGS. 6A, 6B, 6C and 6D are diagrams illustrating a manufacturing step of the coil component of FIG. 1.

FIGS. 7A, 7B, 7C and 7D are diagrams illustrating a manufacturing step of the coil component of FIG. 1.

FIGS. 8A, 8B, 8C and 8D are diagrams illustrating a manufacturing step of the coil component of FIG. 1.

FIGS. 9A, 9B, 9C and 9D are diagrams illustrating a manufacturing step of the coil component of FIG. 1.

FIGS. 10A, 10B, 10C and 10D are diagrams illustrating a manufacturing step of the coil component of FIG. 1.

FIGS. 11A, 11B, 11C and 11D are diagrams illustrating a manufacturing step of the coil component of FIG. 1.

FIG. 12 is a perspective view of a coil component according to a second embodiment.

FIG. 13 is a diagram illustrating an internal configuration of the coil component of FIG. 12.

FIG. 14 is a flowchart illustrating a method for manufacturing the coil component of FIG. 12.

FIGS. 15A, 15B, 15C and 15D are diagrams illustrating a manufacturing step of the coil component of FIG. 12.

FIGS. 16A, 16B, 16C and 16D are diagrams illustrating a manufacturing step of the coil component of FIG. 12.

FIGS. 17A, 17B, 17C and 17D are diagrams illustrating a manufacturing step of the coil component of FIG. 12.

FIGS. 18A, 18B, 18C and 18D are diagrams illustrating a manufacturing step of the coil component of FIG. 12.

FIGS. 19A, 19B, 19C and 19D are diagrams illustrating a manufacturing step of the coil component of FIG. 12.

FIGS. 20A, 20B, 20C and 20D are diagrams illustrating a manufacturing step of the coil component of FIG. 12.

FIGS. 21A, 21B, 21C and 21D are diagrams illustrating a manufacturing step of the coil component of FIG. 12.

FIG. 22 is a perspective view of a coil component according to a third embodiment.

FIGS. 23A and 23B are diagrams illustrating cross-sectional configurations of the coil component of FIG. 22.

FIG. 24 is a flowchart illustrating a method for manufacturing the coil component of FIG. 22.

FIGS. 25A, 25B, 25C and 25D are diagrams illustrating a manufacturing step of the coil component of FIG. 22.

FIGS. 26A, 26B, 26C and 26D are diagrams illustrating a manufacturing step of the coil component of FIG. 22.

FIGS. 27A, 27B, 27C and 27D are diagrams illustrating a manufacturing step of the coil component of FIG. 22.

FIGS. 28A, 28B, 28C and 28D are diagrams illustrating a manufacturing step of the coil component of FIG. 22.

FIGS. 29A, 29B, 29C and 29D are diagrams illustrating a manufacturing step of the coil component of FIG. 22.

FIGS. 30A, 30B, 30C and 30D are diagrams illustrating a manufacturing step of the coil component of FIG. 22.

FIGS. 31A, 31B, 31C and 31D are diagrams illustrating a manufacturing step of the coil component of FIG. 22.

FIGS. 32A, 32B, 32C and 32D are diagrams illustrating a manufacturing step of the coil component of FIG. 22.

FIG. 33 is a perspective view of a coil component according to a fourth embodiment.

FIG. 34 is a diagram illustrating a cross-sectional configuration of the coil component of FIG. 33.

FIG. 35 is a flowchart illustrating a method for manufacturing the coil component of FIG. 33.

FIGS. 36A and 36B are diagrams illustrating a manufacturing step of the coil component of FIG. 33.

FIGS. 37A and 37B are diagrams illustrating a manufacturing step of the coil component of FIG. 33.

FIGS. 38A and 38B are diagrams illustrating a manufacturing step of the coil component of FIG. 33.

FIGS. 39A and 39B are diagrams illustrating a manufacturing step of the coil component of FIG. 33.

FIGS. 40A and 40B are diagrams illustrating a manufacturing step of the coil component of FIG. 33.

FIGS. 41A and 41B are diagrams illustrating a manufacturing step of the coil component of FIG. 33.

FIGS. 42A and 42B are diagrams illustrating a manufacturing step of the coil component of FIG. 33.

FIGS. 43A and 43B are diagrams illustrating a manufacturing step of the coil component of FIG. 33.

FIGS. 44A and 44B are diagrams illustrating a manufacturing step of the coil component of FIG. 33.

FIGS. 45A and 45B are diagrams illustrating a manufacturing step of the coil component of FIG. 33.

FIG. 46 is a diagram illustrating a manufacturing step of the coil component of FIG. 33.

FIGS. 47A and 47B are diagrams illustrating a manufacturing step of the coil component of FIG. 33.

FIGS. 48A and 48B are diagrams illustrating a manufacturing step of a coil component according to a first variation of the first embodiment.

FIG. 49 is a diagram illustrating a cross-sectional configuration of a coil component according to a second variation of the first embodiment.

FIG. 50 is a flowchart illustrating a method for manufacturing the coil component of FIG. 49.

FIGS. 51A, 51B, 51C and 51D are diagrams illustrating a manufacturing step of the coil component of FIG. 49.

FIG. 52 is a flowchart illustrating another method for manufacturing the coil component of FIG. 49.

FIG. 53 is a flowchart illustrating a method for manufacturing a coil component according to a third variation of the first embodiment.

### DETAILED DESCRIPTION

Embodiments will be described in detail below with reference to the accompanying drawings. It should be noted that the same reference signs are given to the same or corresponding elements in the description of the drawings, and redundant description will be omitted.

### First Embodiment

### (Coil Component)

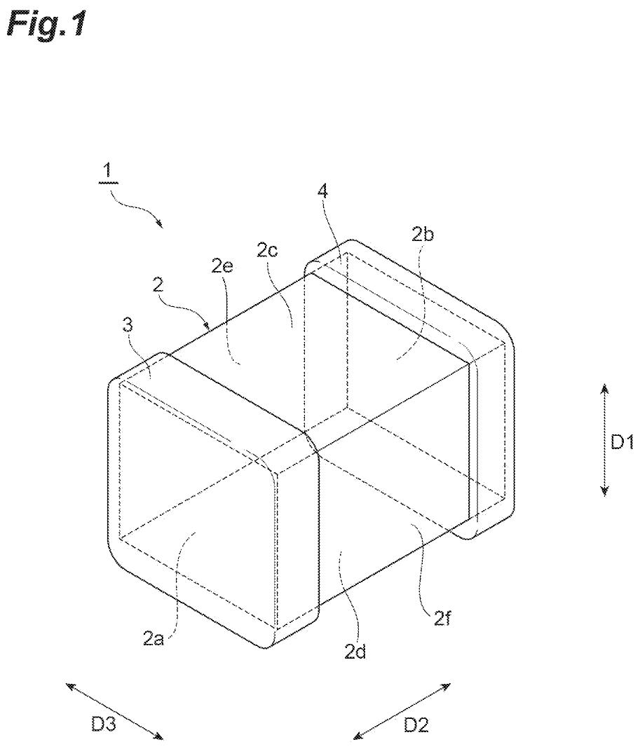

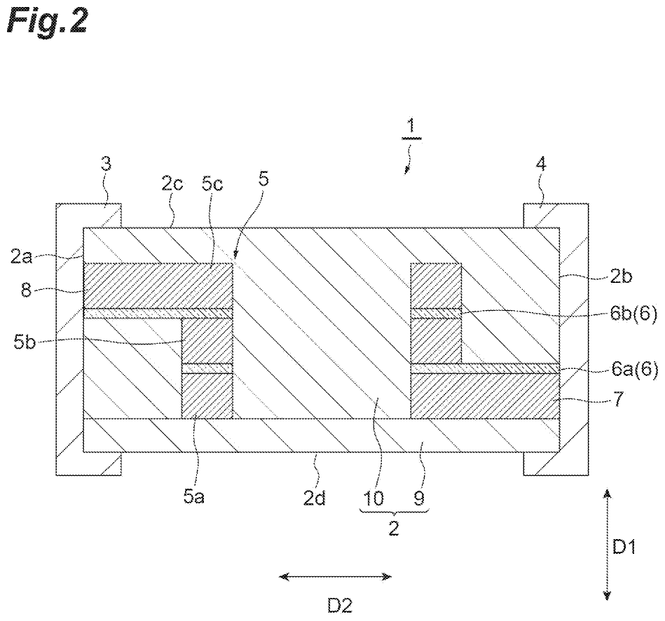

A coil component according to a first embodiment will be described with reference to FIGS. 1 and 2. FIG. 1 is a perspective view of the coil component according to the first embodiment. FIG. 2 is a diagram illustrating a cross-sectional configuration of the coil component shown in FIG. 1. As illustrated in FIGS. 1 and 2, a coil component 1 includes an element body 2, terminal electrodes 3, 4, a coil 5, an insulating layer(s) 6, a connecting conductor 7, and a connecting conductor 8. The coil component 1 is a stacked coil component.

The element body 2 has a rectangular parallelepiped shape. The rectangular parallelepiped shape includes a rectangular parallelepiped shape in which the corners and edges are chamfered, and a rectangular parallelepiped shape in which the corners and edges are rounded. The element body 2 has side surfaces 2a, 2b, 2c, 2d, 2e, 2f as outer surfaces. The side surfaces 2a, 2b face each other. The side surfaces 2c, 2d face each other. The side surfaces 2e, 2f face each other. Hereinafter, a facing direction of side surfaces 2c, 2d will be referred to as a first direction D1, a facing direction of side surfaces 2a, 2b will be referred to as a second direction D2, and a facing direction of side surfaces 2e, 2f will be referred to as a third direction D3. The first direction D1, the second direction D2, and the third direction D3 are substantially orthogonal to each other.

The side surfaces 2a, 2b extend in the first direction D1 so as to connect the side surfaces 2c, 2d. The side surfaces 2a, 2b also extend in the third direction D3 so as to connect the side surfaces 2e, 2f. The side surfaces 2c, 2d extend in the second direction D2 so as to connect the side surfaces 2a, 2b. The side surfaces 2c, 2d also extend in the third direction D3 so as to connect the side surfaces 2e, 2f. The side surfaces 2e, 2f extend in the first direction D1 so as to connect the side surfaces 2c, 2d. The side surfaces 2e, 2f also extend in the second direction D2 so as to connect the side surfaces 2a, 2b.

In this embodiment, for example, the side surface 2d is a mounting surface, and is a surface that faces other electronic devices not shown (e.g., circuit substrates or stacked electronic components) when mounting the coil component 1 on other electronic devices. Side surface 2c, 2e, or 2f may also be a mounting surface.

In this embodiment, a length of the element body 2 in the second direction D2 is greater than a length of the element body 2 in the third direction D3 and a length of the element body 2 in the first direction D1. The length of the element body 2 in the third direction D3 and the length of the element body 2 in the first direction D1 are, for example, equal. That is, in this embodiment, the side surfaces 2a, 2b have a square shape, and the side surfaces 2c, 2d, 2e, 2f have a rectangular shape. The length of the element body 2 in the second direction D2 may be equal to or less than the length of the element body 2 in the third direction D3 and the length of the element body 2 in the first direction D1 . The length of the element body 2 in the third direction D3 and the length of the element body 2 in the first direction D1 may be different from each other.

In this embodiment, the term “equal” means the same, and may also refer to values including minute differences or manufacturing errors within a preset range, and the like. For example, if a plurality of values are within a ±5% range of the average of the plurality of values, it is defined that the plurality of values are equal.

The element body 2 is formed, for example, of an insulating material (a Ni—Cu—Zn ferrite material, a Ni—Cu—Zn—Mn ferrite material, a Ni—Cu ferrite material, and the like). The insulating material that forms the element body 2 may include a Fe alloy and the like. The element body 2 is formed of a magnetic material.

The element body 2 includes a base layer 9 and a filler 10. The base layer 9 includes the entirety of the side surface 2d. The filler 10 is disposed on a surface of the base layer 9 opposite the side surface 2d. The filler 10 is added around the coil 5 without any gaps. The filler 10 includes the entirety of the side surface 2c. The base layer 9 and the filler 10 may be formed of the same or different insulating material.

The terminal electrodes 3, 4 are disposed on the element body 2 facing each other in the second direction D2. The terminal electrodes 3, 4 are spaced from each other in the second direction D2. The terminal electrode 3 is disposed on the side surface 2a of the element body 2. The terminal electrode 3 integrally covers the entirety of the side surface 2a, and end parts of the side surfaces 2c, 2d, 2e, and 2f on the side surface 2a side. The terminal electrode 4 is disposed on the side surface 2b of the element body 2. The terminal electrode 4 covers the entirety of the side surface 2b, and end parts of the side surfaces 2c, 2d, 2e, and 2f on the side surface 2b side. The terminal electrodes 3, 4 include a conductive material (e.g., Ag or Pd). The terminal electrodes 3, 4 are formed as sintered bodies of a conductive paste. The conductive paste includes a conductive metal powder (e.g., Ag powder or Pd powder) and glass frit.

The coil 5 is disposed inside the element body 2. The coil 5 is spaced from the side surfaces 2a, 2b, 2c, 2d, 2e, 2f of the element body 2, and is not exposed from the element body 2. A coil axis of the coil 5 follows along the first direction D1 . The coil 5 includes a plurality of coil conductors 5a, 5b, 5c which are electrically connected to each other. The plurality of coil conductors 5a, 5b, 5c are stacked in that order in the first direction D1 on the base layer 9. Each pair among the plurality of coil conductors 5a, 5b, 5c that are adjacent to each other in a stacking direction (first direction D1) have different shapes from each other. Each pair among the plurality of coil conductors 5a, 5b, 5c that are adjacent to each other in the stacking direction are stacked such that at least a portion of the pair overlap each other. The coil conductor 5a includes one end of the coil 5. The coil conductor 5c includes the other end of the coil 5. It should be noted that the number of the coil conductors is not limited to three.

The coil conductor 5a is disposed on the base layer 9 in contact with the base layer 9. One end of the coil conductor 5a that forms the one end of the coil 5 is connected to the terminal electrode 4 by the connecting conductor 7. The coil conductor 5b is disposed on the coil conductor 5a via one insulating layer 6. One end part of the coil conductor 5b is connected to the other end part of the coil conductor 5a. The coil conductor 5c is disposed on the coil conductor 5b via one insulating layer 6. One end part of the coil conductor 5c is connected to the other end part of the coil conductor 5b. The other end of the coil conductor 5c that forms the other end of the coil 5 is connected to the terminal electrode 3 by the connecting conductor 8. The plurality of coil conductors 5a, 5b, 5c are formed of a conductive material (e.g., Ag or Pd).

The insulating layer(s) 6 includes a plurality of insulating layers 6a, 6b. Each of the insulating layers 6a, 6b is disposed between adjacent pairs of the plurality of coil conductors 5a, 5b, 5c in the stacking direction (first direction D1). The insulating layer 6a is disposed between the coil conductors 5a, 5b. The insulating layer 6b is disposed between the coil conductors 5b, 5c. Each of the insulating layers 6a, 6b is formed to have a width that is the same as or greater than the width of the corresponding coil conductors. The insulating layers 6a, 6b are not disposed between the end parts of the coil conductors adjacent in the stacking direction so as to enable the end parts to be directly connected to each other.

The insulating layer(s) 6 may be formed of the same or different insulating material as that of the element body 2. The insulating layer(s) 6 may be formed of a magnetic or non-magnetic material. The insulating layer(s) 6 may have a single layer structure or a multilayer structure. The insulating layer(s) 6 may have a multilayer structure in which a magnetic layer and a non-magnetic layer are stacked. The insulating layer(s) 6 has a thickness less than the thickness of the coil conductors 5a, 5b, 5c.

The connecting conductor 7 extends in the second direction D2. One end of the connecting conductor 7 is exposed on the side surface 2b and connected to the terminal electrode 4. The other end of the connecting conductor 7 is connected to the one end of the coil 5. The connecting conductor 8 extends in the second direction D2. One end of the connecting conductor 8 is exposed on the side surface 2a and connected to the terminal electrode 3. The other end of the connecting conductor 8 is connected to the other end of the coil 5. The connecting conductors 7, 8 are formed, for example, of a material that is the same as that of the plurality of coil conductors 5a, 5b, 5c.

### (Method for Manufacturing Coil Component)

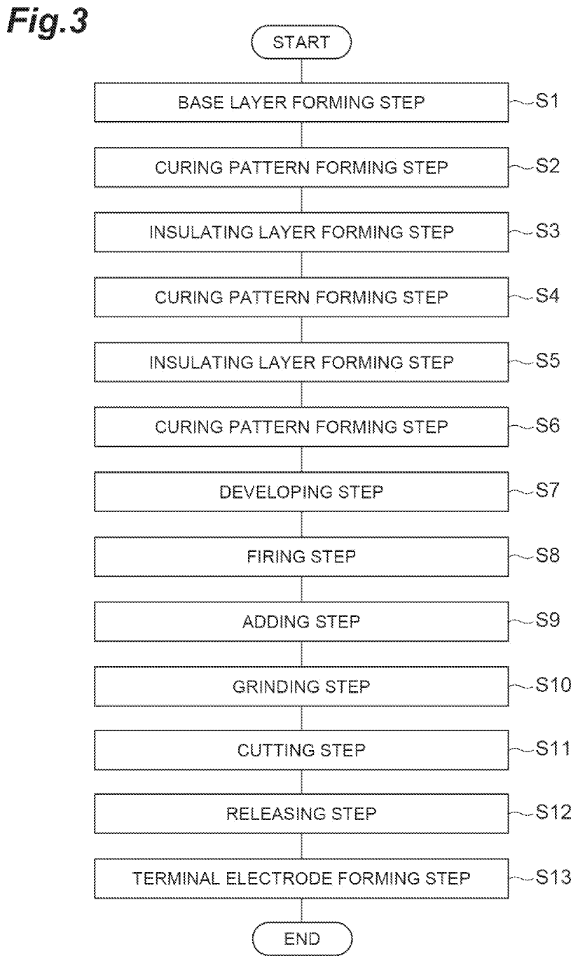

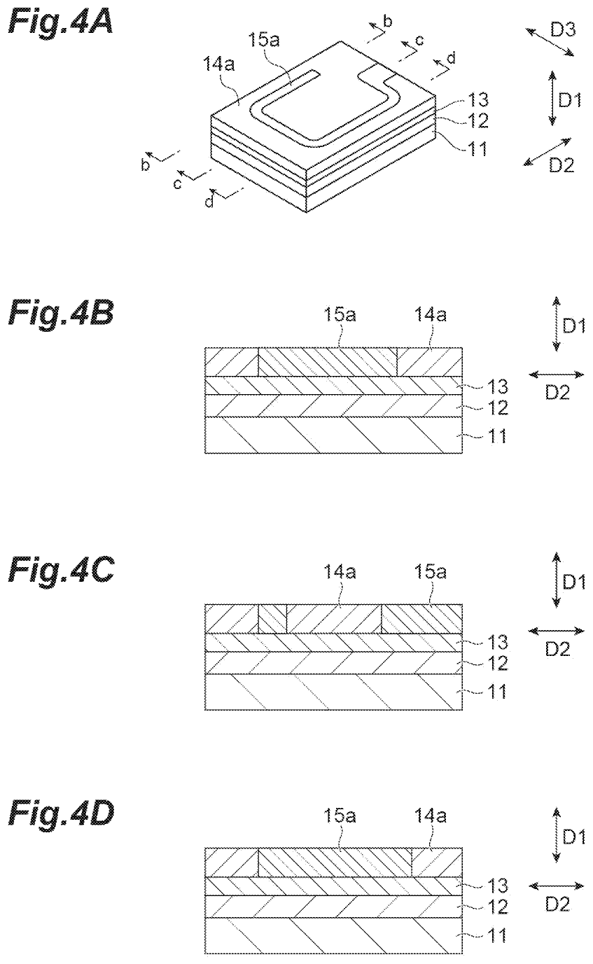

An example of a method for manufacturing the coil component 1 will be described with reference to FIGS. 3 to 11D. FIG. 3 is a flowchart illustrating a method for manufacturing the coil component of FIG. 1. FIGS. 4A, 5A, 6A, 7A, 8A, 9A, 10A and 11A are perspective views in a manufacturing step, FIGS. 4B, 5B, 6B, 7B, 8B, 9B, 10B and 11B are cross-sectional views taken along lines b-b in FIGS. 4A, 5A, 6A, 7A, 8A, 9A, 10A and 11A, FIGS. 4C, 5C, 6C, 7C, 8C, 9C, 10C and 11C are cross-sectional views taken along lines c-c in FIGS. 4A, 5A, 6A, 7A, 8A, 9A, 10A and 11A, and FIGS. 4D, 5D, 6D, 7D, 8D, 9D, 10D and 11D are cross-sectional views taken along lines d-d in FIGS. 4A, 5A, 6A, 7A, 8A, 9A, 10A and 11A. The coil component 1 is manufactured using photolithography. The term “photolithography” herein refers to exposing a layer to be processed that includes a photosensitive material to light and developing the same to form a desired pattern, and is not limited to the type of mask or the like.

As illustrated in FIG. 3, the method for manufacturing the coil component 1 includes a base layer forming step 51, a curing pattern forming step S2, an insulating layer forming step S3, a curing pattern forming step S4, an insulating layer forming step S5, a curing pattern forming step S6, a developing step S7, a firing step S8, an adding step S9, a grinding step S10, a cutting step S11, a releasing step S12, and a terminal electrode forming step S13. Steps 51 to S13 are performed in that order.

The base layer forming step 51 is a step of forming a base layer 13 on a substrate 11. The base layer 13 is the layer to be the base layer 9. A release layer 12 is formed on the substrate 11 in advance. The release layer 12 is formed, for example, of a silicon mold release agent that includes a binder component. The release layer 12 facilitates the release of the base layer 13 from the substrate 11. The release layer 12 need not be provided if the base layer 13 can be released from the substrate 11 by physical force. The base layer 13 is formed by coating the release layer 12 with an insulating paste. The insulating paste is prepared by adding an organic solvent, an organic binder, and the like to a powder of the insulating material that forms the base layer 9, and kneading the mixture.

As illustrated in FIGS. 4A, 4B, 4C and 4D, the curing pattern forming step S2 is a step of applying (e.g., coating) a photosensitive conductive paste 14a on the substrate 11, and exposing the photosensitive conductive paste 14a to light with a pattern corresponding to the coil conductor 5a and the connecting conductor 7 to form a curing pattern 15a. The photosensitive conductive paste 14a is applied specifically on the base layer 13. The photosensitive conductive paste 14a is prepared by adding an organic solvent, an organic binder, and the like to a photosensitive material and a powder of the conductive material that forms the coil 5 and the connecting conductors 7, 8, and kneading the mixture. The photosensitive material is a component that disappears upon light exposure and developing. The photosensitive material may be a negative type or a positive type, and a publicly known photosensitive material can be used. The curing pattern 15a is the pattern to be the coil conductor 5a and the connecting conductor 7. The curing pattern 15a is formed, for example, by exposing the photosensitive conductive paste 14a to ultraviolet rays through a mask having a pattern corresponding to the coil conductor 5a and the connecting conductor 7.

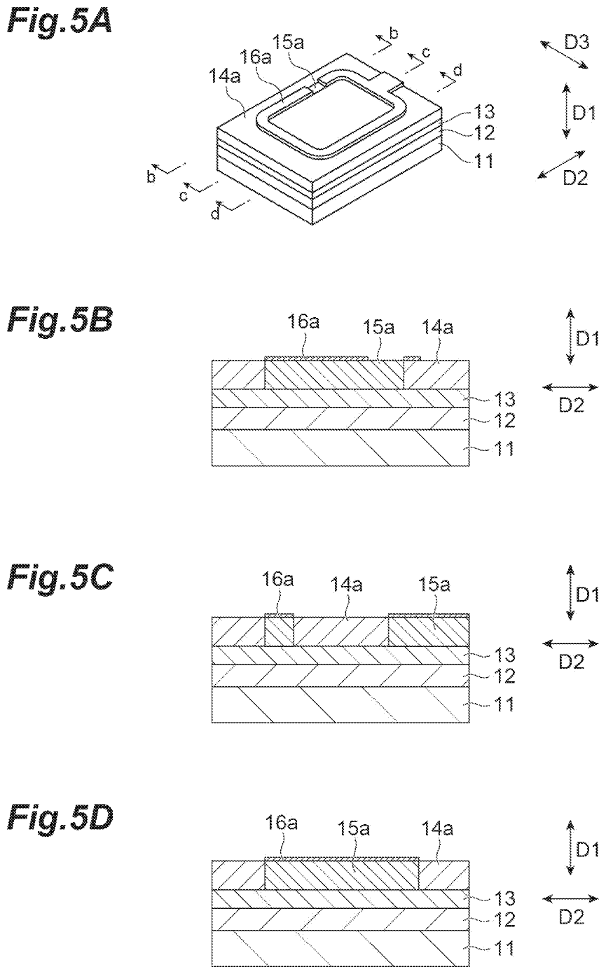

As illustrated in FIGS. 5A, 5B, 5C and 5D, the insulating layer forming step S3 is a step of forming an insulating layer 16a on the curing pattern 15a. The insulating layer 16a is the layer to be the insulating layer 6a. The insulating layer 16a is formed, for example, by coating the curing pattern 15a with an insulating paste by screen printing. The insulating paste is prepared by adding an organic solvent, an organic binder, and the like to a powder of the material that forms the insulating layer 6, and kneading the mixture. The insulating layer 16a has a shape that covers the curing pattern 15a. The insulating layer 16a is not provided on the portion of the curing pattern 15a to be the other end part of the coil conductor 5a to be connected to the coil conductor 5b. The insulating layer 16a may be formed using photolithography.

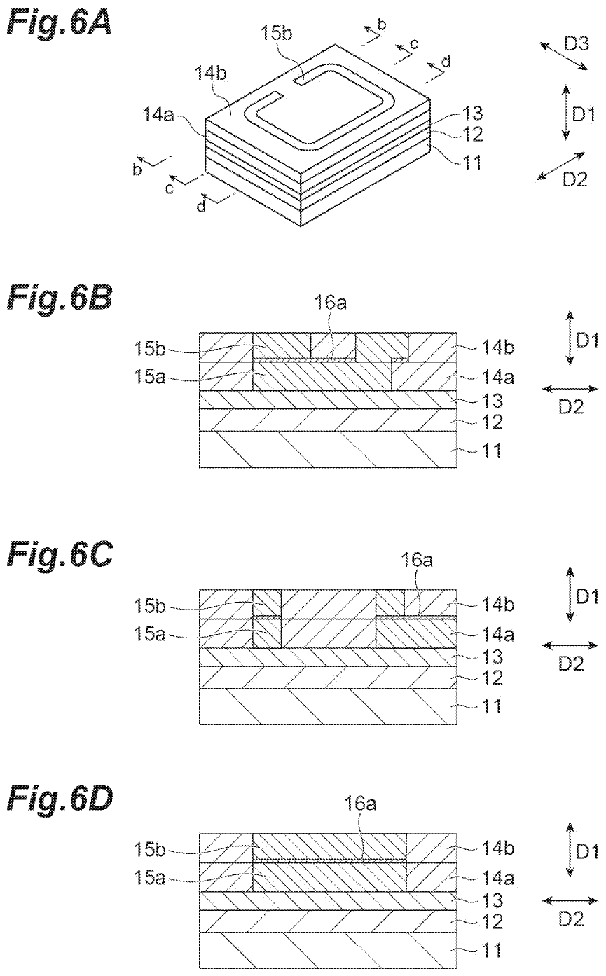

As illustrated in FIGS. 6A, 6B, 6C and 6D, the curing pattern forming step S4 is a step of applying (e.g., coating) a photosensitive conductive paste 14b on the photosensitive conductive paste 14a and the insulating layer 16a, and exposing the photosensitive conductive paste 14b to light with a pattern corresponding to the coil conductor 5b to form a curing pattern 15b. The curing pattern 15b is the pattern to be the coil conductor 5b. The photosensitive conductive paste 14b and the curing pattern 15b are formed in a manner similar to that of the photosensitive conductive paste 14a and the curing pattern 15a. As illustrated in FIG. 6B, the curing pattern 15b is formed to be directly connected to the portion of the curing pattern 15a on which the insulating layer 16a is not provided.

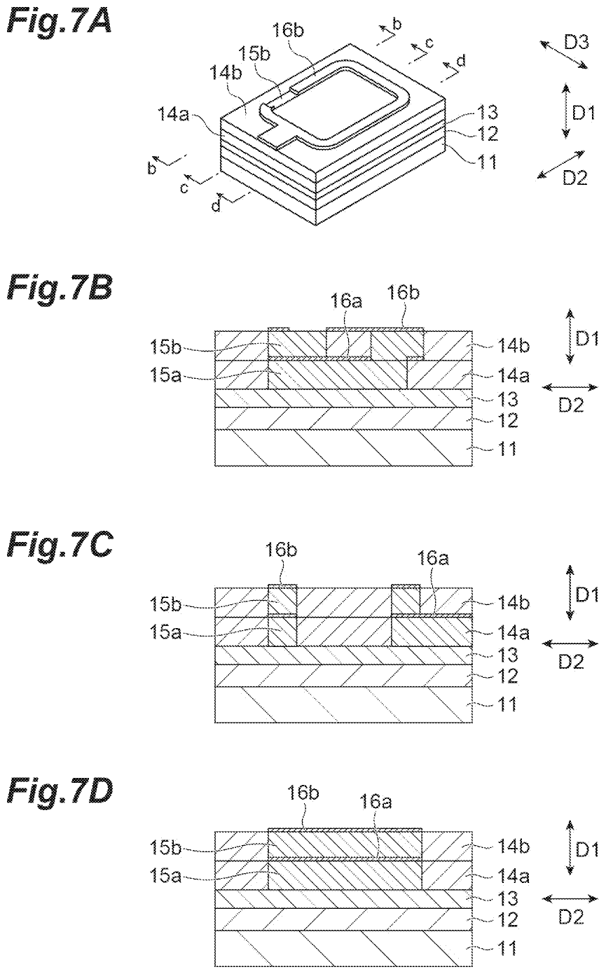

As illustrated in FIGS. 7A, 7B, 7C and 7D, the insulating layer forming step S5 is a step of forming an insulating layer 16b on the curing pattern 15b. The insulating layer 16b is the layer to be the insulating layer 6b. The insulating layer 16b is formed in a manner similar to that of the insulating layer 16a. The insulating layer 16b has a shape that covers the curing pattern 15b. The insulating layer 16b is not provided on the portion of the curing pattern 15b to be the other end part of the coil conductor 5b to be connected to the coil conductor 5c.

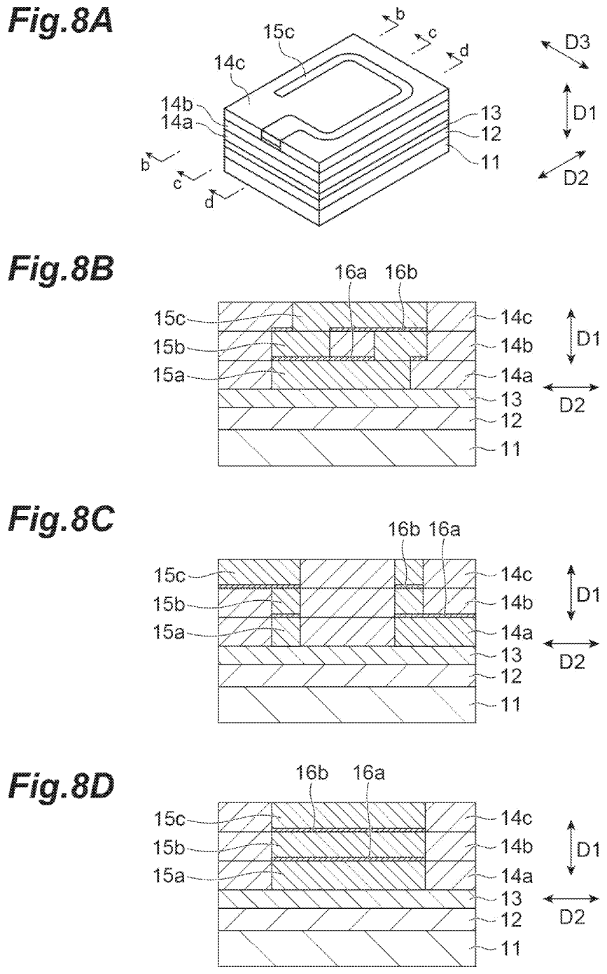

As illustrated in FIGS. 8A, 8B, 8C and 8D, the curing pattern forming step S6 is a step of applying (e.g., coating) a photosensitive conductive paste 14c on the photosensitive conductive paste 14b and the insulating layer 16b, and exposing the photosensitive conductive paste 14c to light with a pattern corresponding to the coil conductor 5c and the connecting conductor 8 to form a curing pattern 15c. The curing pattern 15c is the pattern to be the coil conductor 5c and the connecting conductor 8. The photosensitive conductive paste 14c and the curing pattern 15c are formed in a manner similar to that of the photosensitive conductive paste 14a and the curing pattern 15a. As illustrated in FIG. 8B, the curing pattern 15c is formed to be directly connected to the portion of the curing pattern 15b on which the insulating layer 16b is not provided.

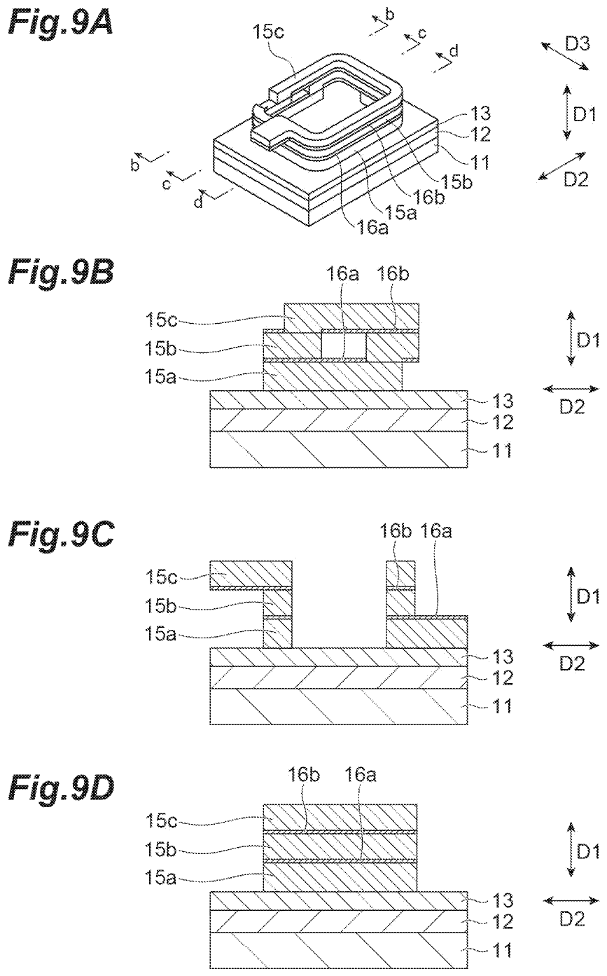

As illustrated in FIGS. 9A, 9B, 9C and 9D, the developing step S7 is a step of developing portions of the photosensitive conductive pastes 14a, 14b, 14c that were not exposed together with a developer. This causes the curing patterns 15a, 15b, 15c and the insulating layers 16a, 16b to remain on the base layer 13.

The firing step S8 is a step of firing the base layer 13, the curing patterns 15a, 15b, 15c, and the insulating layers 16a, 16b that remain after developing, together with the substrate 11 and the release layer 12. The base layer 13 thus becomes the base layer 9. The curing patterns 15a, 15b, 15c become the coil conductors 5a, 5b, 5c, and the connecting conductors 7, 8. The insulating layers 16a, 16b become the insulating layers 6a, 6b.

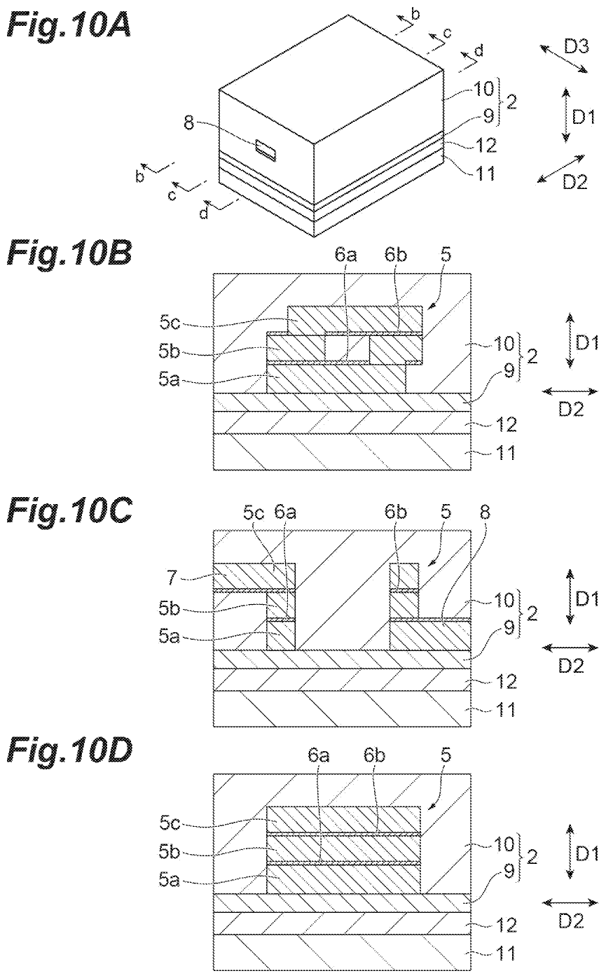

As illustrated in FIGS. 10A, 10B, 10C and 10D, the adding step S9 is a step of adding an insulating material 17 on the substrate 11. The insulating material 17 is the material to be the filler 10. The insulating material 17 is added around the coil 5, the insulating layer(s) 6, and the connecting conductors 7, 8 without any gaps. The insulating material 17 is, for example, an insulating paste that is prepared by adding an organic solvent, an organic binder, and the like to a powder of the insulating material that forms the filler 10, and kneading the mixture. The insulating paste for forming the insulating material 17 may be the same as or different from the insulating paste for forming the base layer 13. In this embodiment, the insulating material 17 is cured by drying to become the filler 10. The adding step S9 may be performed by vacuum printing. In this case, the formation of voids will be suppressed.

The grinding step S10 is a step of grinding an upper surface of the filler 10 to adjust the thickness (film thickness) of the filler 10 on the coil conductor 5c.

The cutting step S11 is a step of cutting an intermediate product obtained in the grinding step S10. Although only the portion corresponding to one coil component 1 is illustrated in FIGS. 4A to 10D, in practice, a plurality of portions corresponding to a plurality of the coil components 1 are arranged in the second direction D2 and the third direction D3 and integrally formed. The cutting step S11 is a step of singulating the plurality of these portions.

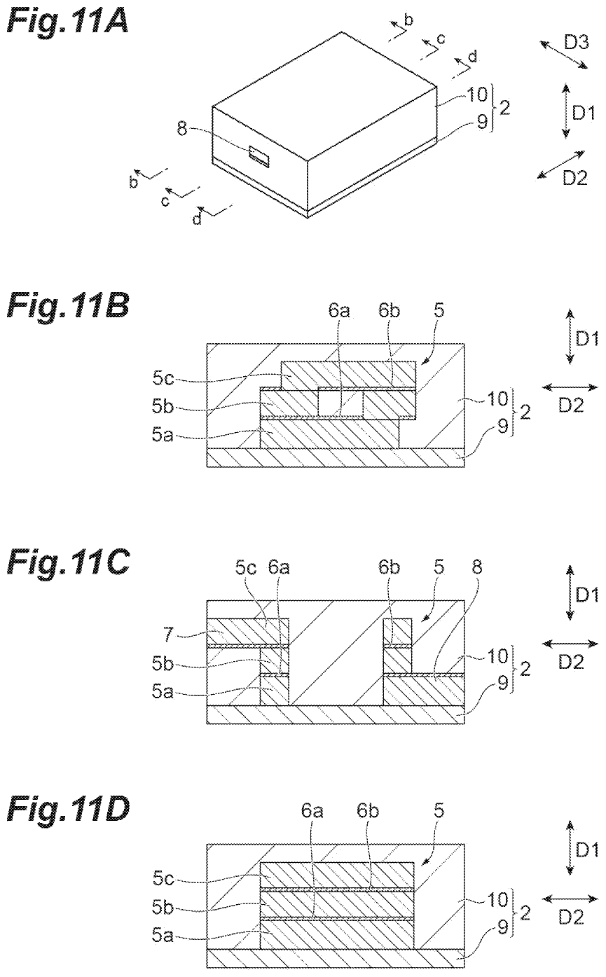

The releasing step S12 is a step of releasing the substrate 11 from the base layer 9. The substrate 11 is released from the base layer 9 together with the release layer 12. Thus, as illustrated in FIGS. 11A, 11B, 11C and 11D, the element body 2 including the base layer 9 and the filler 10, and the coil 5 and the insulating layer(s) 6 disposed inside the element body 2 are obtained. The terminal electrode forming step S13 is a step of forming the terminal electrodes 3, 4 on the side surfaces 2a, 2b of the element body 2. The terminal electrodes 3, 4 are formed, for example, by applying a conductive paste on the side surfaces 2a, 2b, and baking the conductive paste. Consequently, the coil component 1 is obtained.

In the method for manufacturing the coil component 1 as described above, the photosensitive conductive pastes 14a, 14b, 14c are exposed to light and the curing patterns 15a, 15b, 15c are formed in the curing pattern forming steps S2, S4, S6, respectively, and then the portions of the photosensitive conductive pastes 14a, 14b, 14c that were not exposed are developed together in the developing step S7. Thus, an increase in the number of steps can be suppressed while the forming surfaces on which the insulating layer 16a, the photosensitive conductive paste 14b, the insulating layer 16b, and the photosensitive conductive paste 14c are formed are kept flat. The number of steps can also be reduced compared to conventional methods which repeat light exposure and developing. It should be noted that steps are formed by the insulating layers 16a, 16b on the forming surfaces on which the photosensitive conductive pastes 14b, 14c are formed. However, the insulating layers 16a, 16b are thin, so that the forming surfaces on which the photosensitive conductive pastes 14b, 14c are formed are substantially flat.

If, after the curing pattern forming step S2, the portion of the photosensitive conductive paste 14a that was not exposed is developed before the curing pattern forming step S4, a step will be formed between the position in which the curing pattern 15a exists and the position in which the curing pattern 15a does not exist. If the forming surface for forming the photosensitive conductive paste 14b is a stepped surface, stack misalignment may occur. A method of coating the curing pattern 15a with an insulating material before the curing pattern forming step S4 to fill the step may be contemplated. However, securely filling the step to smooth the surface of the insulating material will make it difficult for the insulating material on the curing pattern 15a to be thin, and the coil component 1 will tend to be large. On the other hand, thinning the insulating material on the curing pattern 15a will make it difficult to securely fill the step to smooth the surface of the insulating material.

In contrast, in the method for manufacturing the coil component 1, because the portion of the photosensitive conductive paste 14a that was not exposed remains, the forming surface for forming the photosensitive conductive paste 14b is kept flat. Stack misalignment can thus be suppressed. The insulating layer 16a that is thin can be formed on the curing pattern 15a in the insulating layer forming step S3, since the need to fill a step by the insulating layer 16a is eliminated. The coil component 1 can thus be made small.

A conventional manufacturing method includes a method of sequentially transferring a magnetic layer (or an insulating sheet) and a coil conductor formed on a base material onto a substrate to stack the coil conductors. In this method, the magnetic layers and the coil conductors are pressed after being stacked, causing the coil conductor to deform. It is thus difficult to increase the aspect ratio of the coil conductors. The magnetic properties may also be reduced due to residual stress generated in the magnetic layers.

In contrast, the need to press the curing patterns 15a, 15b, 15c to be the coil conductors 5a, 5b, 5c is eliminated in the method for manufacturing the coil component 1, so that the coil conductors 5a, 5b, 5c do not tend to deform, and the aspect ratio can be easily increased. Additionally, generation of residual stress in the magnetic layers is suppressed, so that the reduction in the magnetic properties is also suppressed. Furthermore, the coil component 1 can be made small while suppressing electrical short circuit between the coil conductors 5a, 5b, 5c.

The method for manufacturing the coil component 1 includes the insulating layer forming step S3 between the curing pattern forming step S2 and the curing pattern forming step S4, and includes the insulating layer forming step S5 between the curing pattern forming step S4 and the curing pattern forming step S6. The increase in the number of steps can be suppressed while keeping the forming surfaces flat even in the case in which the insulating layer 16a is disposed between the curing pattern 15a and the curing pattern 15b, and in the case in which the insulating layer 16b is disposed between the curing pattern 15b and the curing pattern 15c. The number of steps can also be reduced compared to conventional methods which repeat light exposure and developing.

The method for manufacturing the coil component 1 includes the firing step S8 between the developing step S7 and the adding step S9. This enables a material having low heat resistance, such as a Fe powder (pure iron powder), a carbonyl iron powder, or a Fe alloy powder such as FeNi, FeCo, or FeSi (or a soft magnetic metal material) to be used as the insulating material 17 to be added.

### Second Embodiment

### (Coil Component)

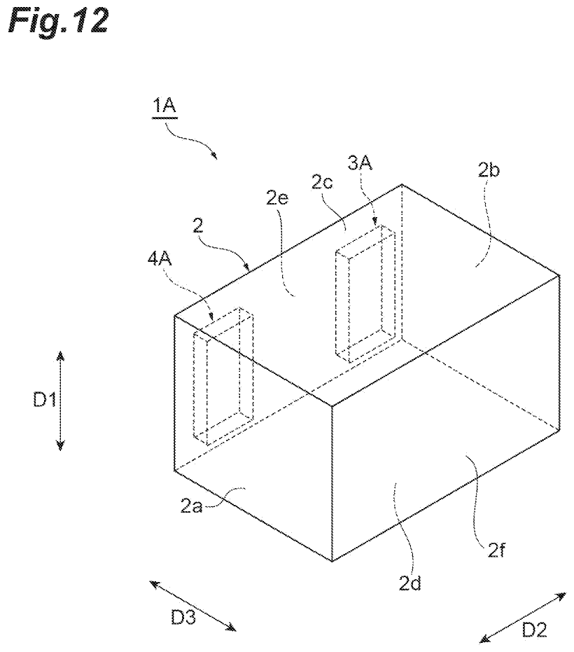

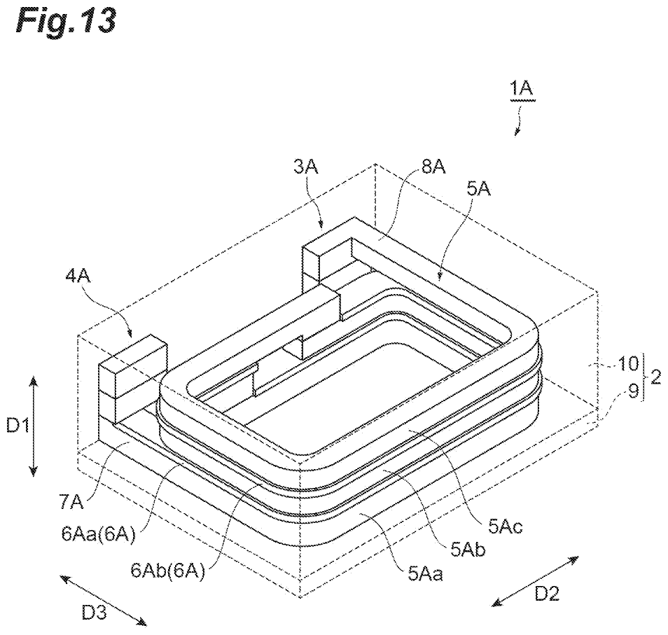

A coil component according to a second embodiment will be described with reference to FIGS. 12 and 13. FIG. 12 is a perspective view illustrating an internal configuration of the coil component according to the second embodiment. FIG. 13 is a perspective view illustrating the internal configuration of the coil component of FIG. 12. In FIG. 13, the element body 2 is illustrated in dashed lines. As illustrated in FIGS. 12 and 13, a coil component 1A includes the element body 2, terminal electrodes 3A, 4A, a coil 5A, an insulating layer(s) 6A, and connecting conductors 7A, 8A. Common features with the coil component 1 will be omitted as appropriate in the description below.

In this embodiment, the side surface 2e is the mounting surface. The terminal electrodes 3A, 4A are disposed on the side surface 2e spaced from each other in the second direction D2. The terminal electrode 3A is disposed closer to the side surface 2b. The terminal electrode 4A is disposed closer to the side surface 2a. The terminal electrodes 3A, 4A are disposed spaced from outer edges of the side surface 2e. The terminal electrodes 3A, 4A are disposed in recessed parts formed in the side surface 2e. The terminal electrodes 3A, 4A are embedded in the element body 2 so as to be exposed on the side surface 2e. Surfaces of the terminal electrodes 3A, 4A are substantially flush with the side surface 2e. The terminal electrodes 3A, 4A have the same shape when viewed in the third direction D3. The terminal electrodes 3A, 4A have a rectangular shape with the first direction D1 being the long side direction when viewed in the third direction D3.

The terminal electrodes 3A, 4A include a plurality of terminal electrode layers stacked in the first direction D1 . The plurality of terminal electrode layers are integrated such that the boundaries between the layers are not visible. The terminal electrodes 3A, 4A are formed, for example, of the same material as that of the coil 5A.

The coil 5A is disposed inside the element body 2. The coil 5A is spaced from the side surfaces 2a, 2b, 2c, 2d, 2e, 2f of the element body 2, and is not exposed from the element body 2. A coil axis of the coil 5A follows along the first direction D1. The coil 5A includes a plurality of coil conductors 5Aa, 5Ab, 5Ac which are electrically connected to each other. The plurality of coil conductors 5Aa, 5Ab, 5Ac are stacked in that order in the first direction D1 on the base layer 9. Each pair among the plurality of coil conductors 5Aa, 5Ab, 5Ac that are adjacent to each other in the stacking direction (first direction D1) have different shapes from each other. Each pair among the plurality of coil conductors 5Aa, 5Ab, 5Ac that are adjacent to each other in the stacking direction are stacked such that at least a portion of the pair overlap each other. The coil conductor 5Aa includes one end of the coil 5A. The coil conductor 5Ac includes the other end of the coil 5A.

The coil conductor 5Aa is disposed on the base layer 9 in contact with the base layer 9. One end of the coil conductor 5Aa that forms the one end of the coil 5A is connected to the terminal electrode 4A by the connecting conductor 7A. The coil conductor 5Ab is disposed on the coil conductor 5Aa via one insulating layer 6A. One end part of the coil conductor 5Ab is connected to the other end part of the coil conductor 5Aa. The coil conductor 5Ac is disposed on the coil conductor 5Ab via one insulating layer 6A. One end part of the coil conductor 5Ac is connected to the other end part of the coil conductor 5Ab. The other end of the coil conductor 5Ac that forms the other end of the coil 5A is connected to the terminal electrode 3A by the connecting conductor 8A.

The insulating layer(s) 6A includes a plurality of insulating layers 6Aa, 6Ab. Each of the insulating layers 6Aa, 6Ab is disposed between adjacent pairs of the plurality of coil conductors 5Aa, 5Ab, 5Ac in the stacking direction (first direction D1). The insulating layer 6Aa is disposed between the coil conductors 5Aa, 5Ab. The insulating layer 6Ab is disposed between the coil conductors 5Ab, 5Ac. Each of the insulating layers 6Aa, 6Ab is formed to have a width that is the same as or greater than the width of the corresponding coil conductors. The insulating layers 6Aa, 6Ab are not disposed between end parts of the coil conductors adjacent in the stacking direction so as to enable the end parts to be directly connected to each other.

The insulating layer(s) 6A may be formed of the same or different insulating material as that of the element body 2. The insulating layer(s) 6A may be formed of a magnetic or non-magnetic material. The insulating layer(s) 6A may have a single layer structure or a multilayer structure. The insulating layer(s) 6A may have a multilayer structure in which a magnetic layer and a non-magnetic layer are stacked.

The connecting conductor 7A extends in the third direction D3, and is connected to the terminal electrode 4A and the one end of the coil 5A. The connecting conductor 8A extends in the third direction D3, and is connected to the terminal electrode 3A and the other end of the coil 5A. The connecting conductors 7A, 8A are formed, for example, of the same material as that of the plurality of coil conductors 5Aa, 5Ab, 5Ac.

### (Method for Manufacturing Coil Component)

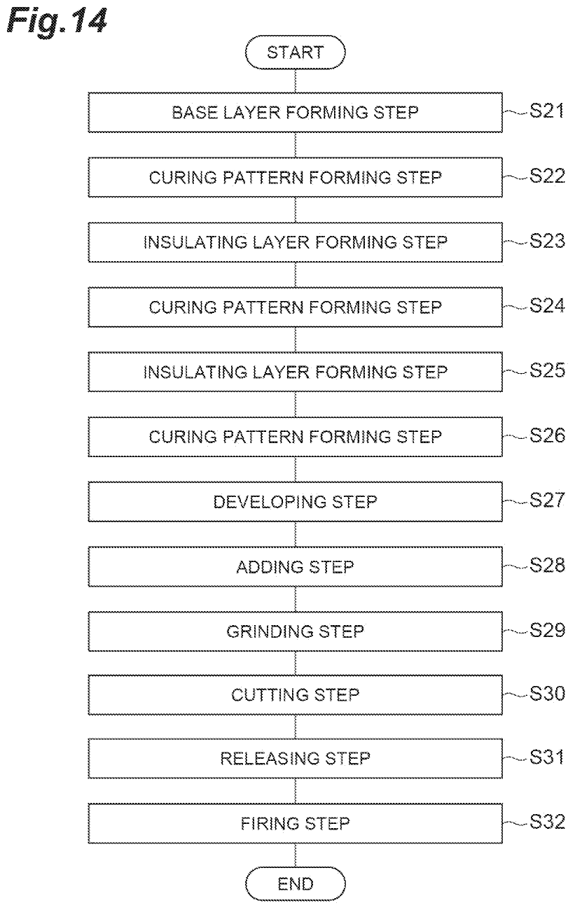

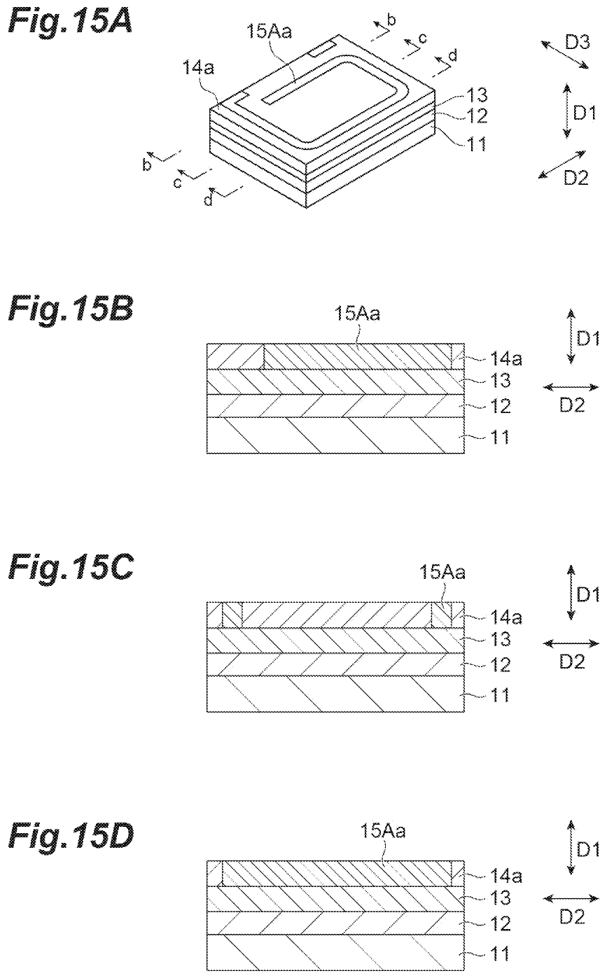

An example of a method for manufacturing the coil component 1A will be described next with reference to FIGS. 14 to 21D. FIG. 14 is a flowchart illustrating a method for manufacturing the coil component of FIG. 12. FIGS. 15A, 16A, 17A, 18A, 19A, 20A and 21A are perspective views in a manufacturing step, FIGS. 15B, 16B, 17B, 18B, 19B, 20B and 21B are cross-sectional views taken along lines b-b in 15A, 16A, 17A, 18A, 19A, 20A and 21A, FIGS. 15C, 16C, 17C, 18C, 19C, 20C and 21C are cross-sectional views taken along lines c-c in 15A, 16A, 17A, 18A, 19A, 20A and 21A, and 15D, 16D, 17D, 18D, 19D, 20D and 21D are cross-sectional views taken along lines d-d in 15A, 16A, 17A, 18A, 19A, 20A and 21A. Common features with the method for manufacturing the coil component 1 will be omitted as appropriate in the description below.

As illustrated in FIG. 14, the method for manufacturing the coil component 1A includes a base layer forming step S21, a curing pattern forming step S22, an insulating layer forming step S23, a curing pattern forming step S24, an insulating layer forming step S25, a curing pattern forming step S26, a developing step S27, an adding step S28, a grinding step S29, a cutting step S30, a releasing step S31, and a firing step S32. Steps S21 to S32 are performed in that order.

The base layer forming step S21 is the same as the base layer forming step 51. In this embodiment, the release layer 12 also need not be provided if the base layer 13 can be released from the substrate 11 by physical force.

As illustrated in FIGS. 15A, 15B, 15C and 15D, the curing pattern forming step S22 is a step of applying (e.g., coating) the photosensitive conductive paste 14a on the substrate 11, and exposing the photosensitive conductive paste 14a to light with a pattern corresponding to the coil conductor 5Aa, the connecting conductor 7A, and the terminal electrodes 3A, 4A to form a curing pattern 15Aa. The photosensitive conductive paste 14a is applied specifically on the base layer 13. The curing pattern 15Aa is the pattern to be the coil conductor 5Aa, the connecting conductor 7A, and the terminal electrodes 3A, 4A.

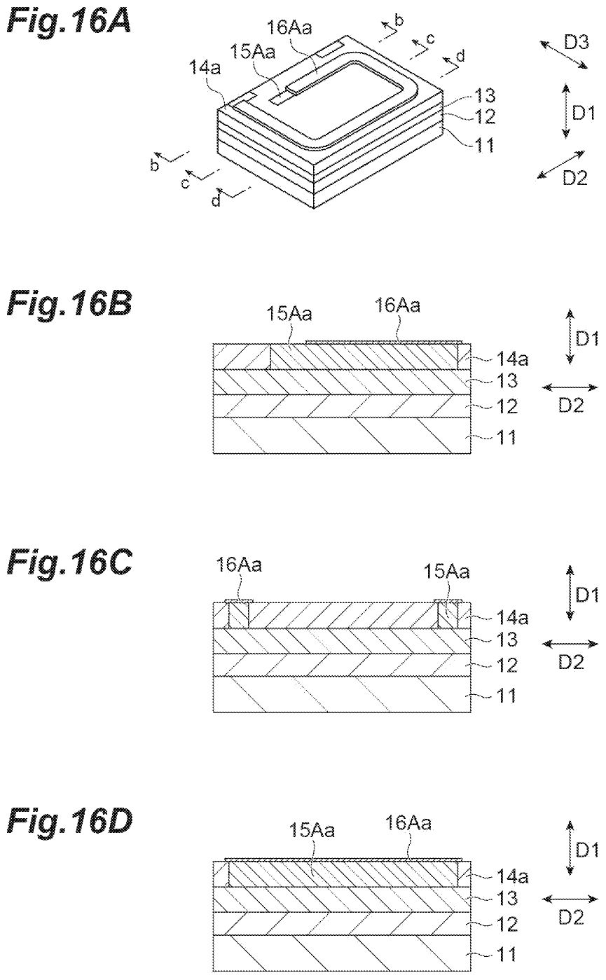

As illustrated in FIGS. 16A, 16B, 16C and 16D, the insulating layer forming step S23 is a step of forming an insulating layer 16Aa on the curing pattern 15Aa. The insulating layer 16Aa is the layer to be the insulating layer 6Aa. The insulating layer 16Aa is formed in a manner similar to that of the insulating layer 16a. The insulating layer 16Aa has a shape that covers the curing pattern 15Aa. The insulating layer 16Aa is not provided on the portion of the curing pattern 15Aa to be the other end part of the coil conductor 5Aa to be connected to the coil conductor 5Ab, or the portions to be the terminal electrodes 3A, 4A.

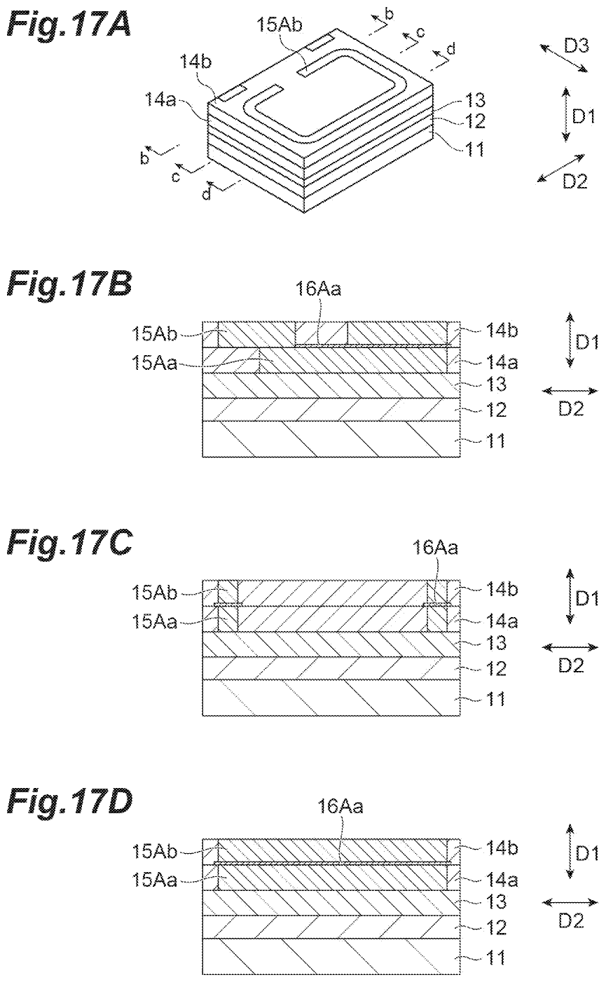

As illustrated in FIGS. 17A, 17B, 17C and 17D, the curing pattern forming step S24 is a step of applying (e.g., coating) the photosensitive conductive paste 14b on the photosensitive conductive paste 14a and the insulating layer 16Aa, and exposing the photosensitive conductive paste 14b to light with a pattern corresponding to the coil conductor 5Ab and the terminal electrodes 3A, 4A to form a curing pattern 15Ab. The curing pattern 15Ab is the pattern to be the coil conductor 5Ab and the terminal electrodes 3A, 4A. The photosensitive conductive paste 14b and the curing pattern 15Ab are formed in a manner similar to that of the photosensitive conductive paste 14a and the curing pattern 15Aa. As illustrated in FIG. 17B, the curing pattern 15Ab is formed to be directly connected to the portion of the curing pattern 15Aa on which the insulating layer 16Aa is not provided.

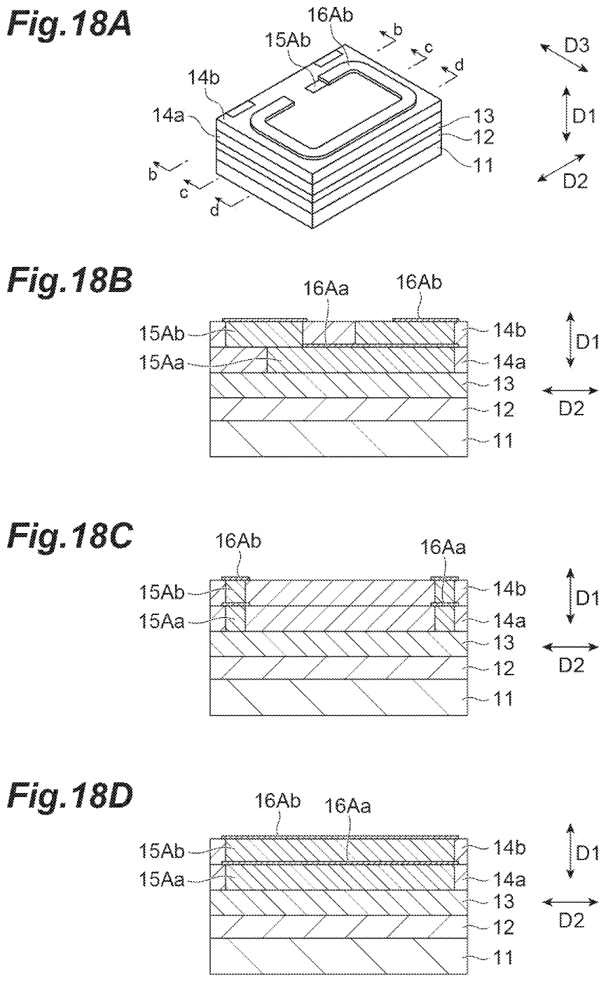

As illustrated in FIGS. 18A, 18B, 18C and 18D, the insulating layer forming step S25 is a step of forming an insulating layer 16Ab on the curing pattern 15Ab. The insulating layer 16Ab is the layer to be the insulating layer 6Ab. The insulating layer 16Ab is formed in a manner similar to that of the insulating layer 16b. The insulating layer 16Ab has a shape that covers the curing pattern 15Ab. The insulating layer 16Ab is not provided on the portion of the curing pattern 15Ab to be the other end part of the coil conductor 5Ab to be connected to the coil conductor 5Ac, or the portions to be the terminal electrodes 3A, 4A.

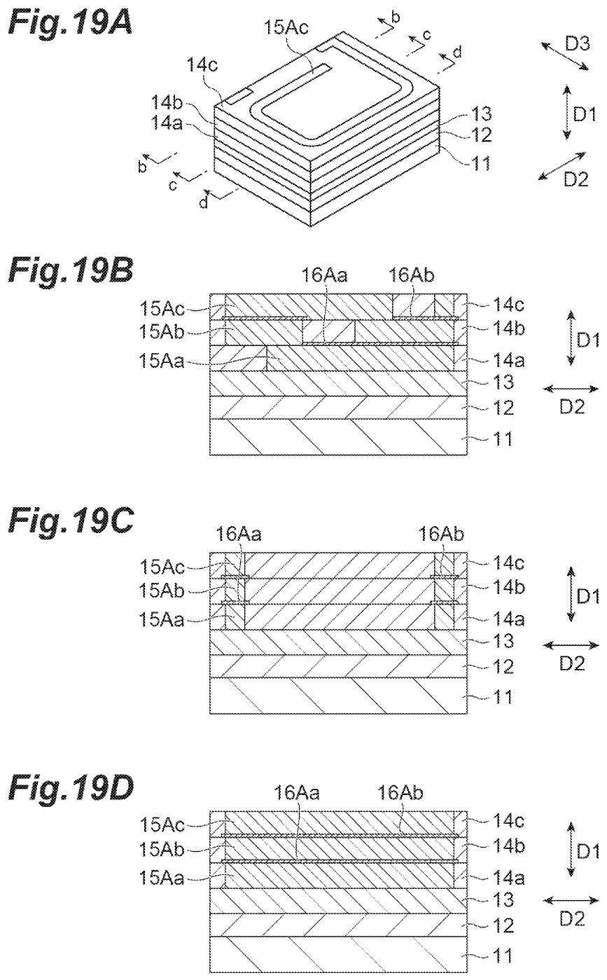

As illustrated in FIGS. 19A, 19B, 19C and 19D, the curing pattern forming step S26 is a step of applying (e.g., coating) the photosensitive conductive paste 14c on the photosensitive conductive paste 14b and the insulating layer 16Ab, and exposing the photosensitive conductive paste 14c to light with a pattern corresponding to the coil conductor 5Ac, the connecting conductor 8A, and the terminal electrodes 3A, 4A to form a curing pattern 15Ac. The curing pattern 15Ac is the pattern to be the coil conductor 5Ac, the connecting conductor 8A, and the terminal electrodes 3A, 4A. The photosensitive conductive paste 14c and the curing pattern 15Ac are formed in a manner similar to that of the photosensitive conductive paste 14a and the curing pattern 15Aa. As illustrated in FIG. 19B, the curing pattern 15Ac is formed to be directly connected to the portion of the curing pattern 15Ab on which the insulating layer 16Ab is not provided.

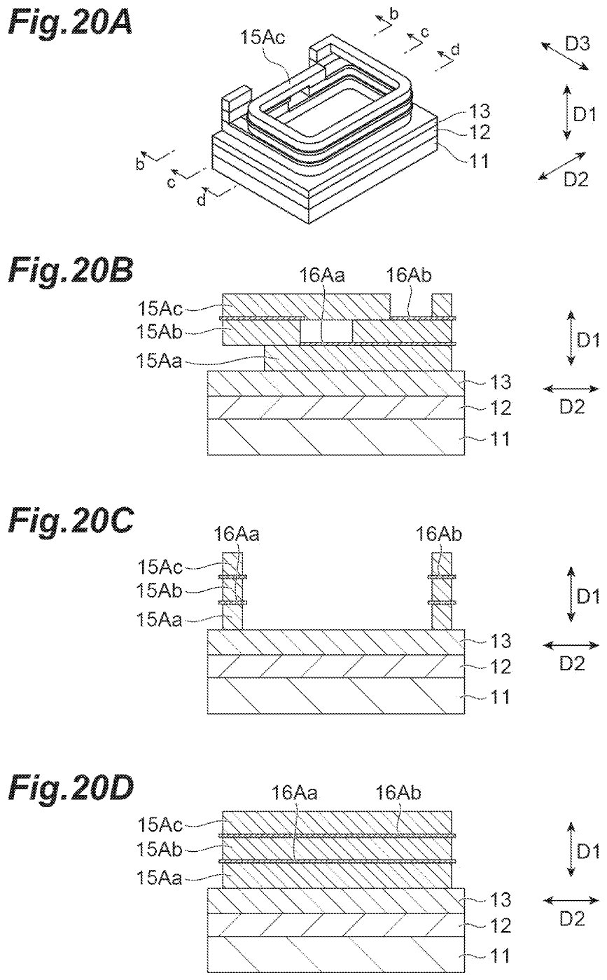

As illustrated in FIGS. 20A, 20B, 20C and 20D, the developing step S27 is a step of developing the portions of the photosensitive conductive pastes 14a, 14b, 14c that were not exposed with a developer. This causes the curing patterns 15Aa, 15Ab, 15Ac and the insulating layers 16Aa, 16Ab to remain on the base layer 13.

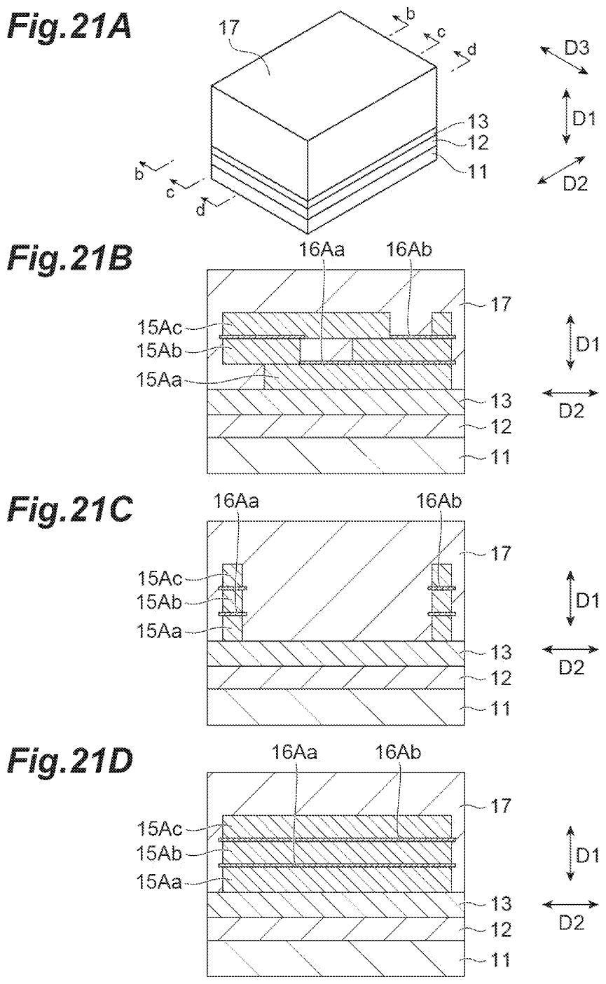

As illustrated in FIGS. 21A, 21B, 21C and 21D, the adding step S28 is a step of adding the insulating material 17 on the substrate 11. The insulating material 17 is added around the curing patterns 15Aa, 15Ab, 15Ac and the insulating layers 16Aa, 16Ab without any gaps. In this embodiment, the insulating material 17 is cured by drying.

The grinding step S29 is a step of grinding an upper surface of the insulating material 17 to adjust the thickness (film thickness) of the insulating material 17 on the curing pattern 15Ac.

The cutting step S30 is a step of cutting an intermediate product obtained in the grinding step S29. Although only the portion corresponding to one coil component 1A is illustrated in FIGS. 15A to 21D, in practice, a plurality of portions corresponding to a plurality of the coil components 1A are arranged in the second direction D2 and the third direction D3 and integrally formed. The cutting step S30 is a step of singulating the plurality of these portions.

The releasing step S31 is a step of releasing the substrate 11 from the base layer 13. The substrate 11 is released from the base layer 13 together with the release layer 12.

The firing step S32 is a step of firing the base layer 13, the curing patterns 15Aa, 15Ab, 15Ac, the insulating layers 16Aa, 16Ab, and the insulating material 17. The base layer 13 thus becomes the base layer 9. The curing patterns 15Aa, 15Ab, 15Ac become the coil conductors 5Aa, 5Ab, 5Ac, the connecting conductors 7A, 8A, and the terminal electrodes 3A, 4A. The insulating layers 16Aa, 16Ab become the insulating layers 6Aa, 6Ab. The insulating material 17 becomes the filler 10. The coil component 1A is thus obtained.

Similarly, in the method for manufacturing the coil component 1A as described above, the photosensitive conductive pastes 14a, 14b, 14c are exposed to light and the curing patterns 15Aa, 15Ab, 15Ac are formed in the curing pattern forming steps S22, S24, S26, respectively, and then the portions of the photosensitive conductive pastes 14a, 14b, 14c that were not exposed are developed together in the developing step S27. Thus, the increase in the number of steps can be suppressed while keeping the forming surfaces flat. The number of steps can also be reduced compared to conventional methods which repeat light exposure and developing.

In the method for manufacturing the coil component 1A, the firing step S32 is performed after the adding step S28. This enables a material that exhibits magnetism by firing such as ferrite to be used as the insulating material 17 to be added.

The method for manufacturing the coil component 1A includes, before the developing step S27, the curing pattern forming steps S22, S24, S26 in which the photosensitive conductive pastes 14a, 14b, 14c to be the terminal electrodes 3A, 4A to be connected to the coil 5A are formed on the substrate 11. The terminal electrodes 3A, 4A can thus be formed together with the coil 5A. The number of steps can further be reduced, since the need to form the terminal electrodes 3A, 4A after forming the coil 5A is eliminated.

### Third Embodiment

### (Coil Component)

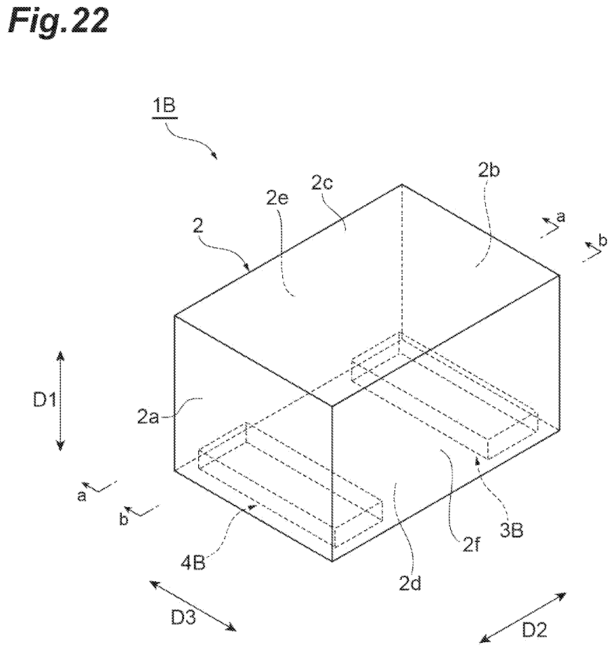

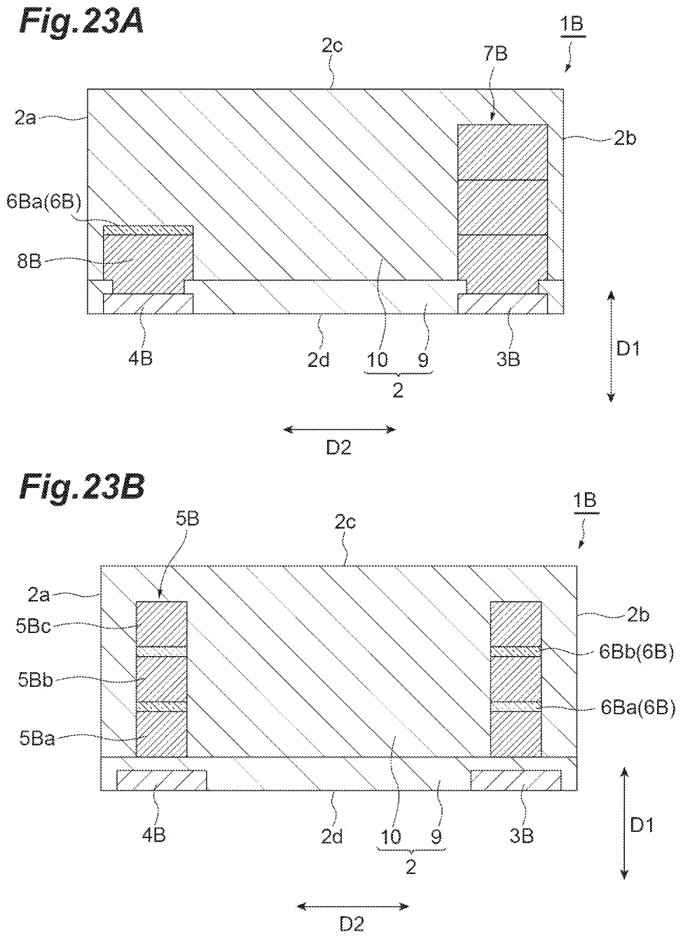

A coil component according to a third embodiment will be described with reference to FIGS. 22, 23A and 23B. FIG. 22 is a perspective view of the coil component according to the third embodiment. FIG. 23A is a cross-sectional view taken along line a-a in FIG. 22. FIG. 23B is a cross-sectional view taken along line b-b in FIG. 22. As illustrated in FIGS. 22, 23A and 23B, a coil component 1B includes the element body 2, terminal electrodes 3B, 4B, a coil 5B, an insulating layer(s) 6B, and connecting conductors 7B, 8B. Common features with the coil component 1A will be omitted as appropriate in the description below.

In this embodiment, the side surface 2d is the mounting surface. The terminal electrodes 3B, 4B are disposed on the side surface 2d spaced from each other in the second direction D2. The terminal electrode 3B is disposed closer to the side surface 2b. The terminal electrode 4B is disposed closer to the side surface 2a. The terminal electrodes 3B, 4B are disposed spaced from outer edges of the side surface 2d. The terminal electrodes 3B, 4B are disposed in recessed parts formed in the side surface 2d. The terminal electrodes 3B, 4B are embedded in the element body 2 so as to be exposed on the side surface 2d. Surfaces of the terminal electrodes 3B, 4B are substantially flush with the side surface 2d. The terminal electrodes 3B, 4B have a substantially rectangular shape with the third direction D3 being the long side direction when viewed in the first direction D1. The terminal electrodes 3B, 4B include a conductive material (e.g., Ag or Pd).

The coil 5B has the same configuration as that of the coil 5A, and is disposed inside the element body 2 similarly to the coil 5A. The coil 5B includes a plurality of coil conductors 5Ba, 5Bb, 5Bc which are electrically connected to each other. The plurality of coil conductors 5Ba, 5Bb, 5Bc have the same shape as the plurality of coil conductors 5Aa, 5Ab, 5Ac, respectively, and are connected to each other similarly to the plurality of coil conductors 5Aa, 5Ab, 5Ac.

The coil conductor 5Ba is disposed on the base layer 9 spaced from the terminal electrodes 3B, 4B. One end of the coil conductor 5Ba that forms one end of the coil 5B is connected to the terminal electrode 4B by the connecting conductor 8B. The coil conductor 5Bb is disposed on the coil conductor 5Ba via one insulating layer 6B. One end part of the coil conductor 5Bb is connected to the other end part of the coil conductor 5Ba. The coil conductor 5Bc is disposed on the coil conductor 5Bb via one insulating layer 6B. One end part of the coil conductor 5Bc is connected to the other end part of the coil conductor 5Bb. The other end of the coil conductor 5Bc that forms the other end of the coil 5B is connected to the terminal electrode 3B by the connecting conductor 7B.

The insulating layer(s) 6B has the same configuration as that of the insulating layer(s) 6A. The insulating layer(s) 6B includes a plurality of insulating layers 6Ba, 6Bb. Each of the plurality of insulating layers 6Ba, 6Bb is disposed between adjacent pairs of the plurality of coil conductors 5Ba, 5Bb, 5Bc in the stacking direction (first direction D1) similarly to the insulating layers 6Aa, 6Ab.

The connecting conductor 8B extends in the first direction D1, and is connected to the terminal electrode 4B and the one end of the coil 5B. The connecting conductor 7B extends in the first direction D1, and is connected to the terminal electrode 3B and the other end of the coil 5B. The connecting conductor 7B includes a plurality of connecting conductor layers (not shown) that are stacked in the first direction D1 . The plurality of connecting conductor layers are integrated such that the boundaries between the layers are not visible. The connecting conductors 7B, 8B are disposed between the coil 5 and the side surface 2e. The connecting conductors 7B, 8B are formed, for example, of the same material as that of the plurality of coil conductors 5Ba, 5Bb, 5Bc.

The terminal electrodes 3A, 4A are formed, for example, of the same material as that of the coil 5A.

### (Method for Manufacturing Coil Component)

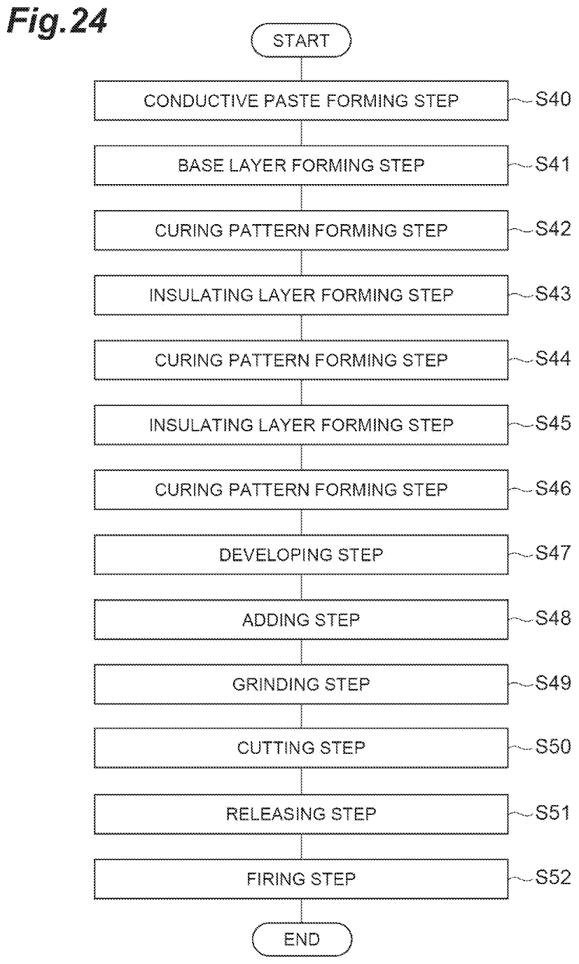

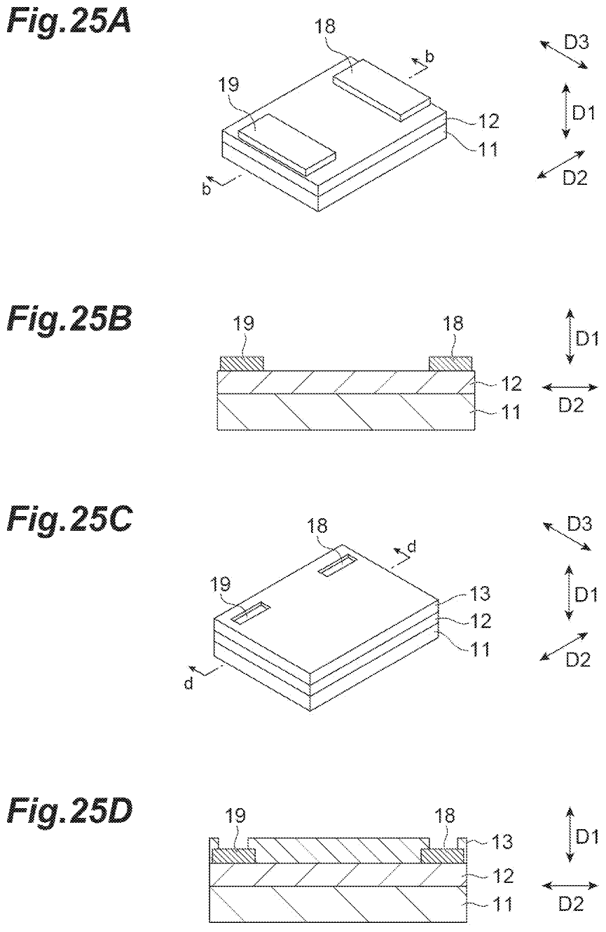

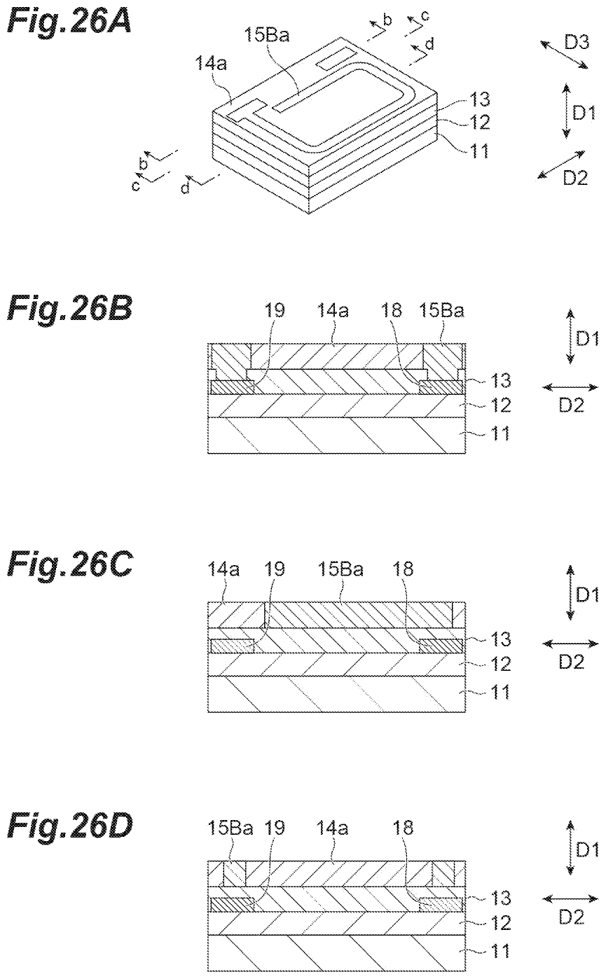

An example of a method for manufacturing the coil component 1B will be described next with reference to FIGS. 24 to 32D. FIG. 24 is a flowchart illustrating a method for manufacturing the coil component of FIG. 22. FIG. 25A is a perspective view in a manufacturing step, FIG. 25B is a cross-sectional view taken along line b-b in FIG. 25A, FIG. 25C is a perspective view in a manufacturing step, and FIG. 25D is a cross-sectional view taken along line d-d in FIG. 25C. FIGS. 26A, 27A, 28A, 29A, 30A, 31A and 32A are perspective views in a manufacturing step, FIGS. 26B, 27B, 28B, 29B, 30B, 31B and 32B are cross-sectional views taken along lines b-b in FIGS. 26A, 27A, 28A, 29A, 30A, 31A and 32A, FIGS. 26C, 27C, 28C, 29C, 30C, 31C and 32C are cross-sectional views taken along lines c-c in FIGS. 26A, 27A, 28A, 29A, 30A, 31A and 32A, and FIGS. 26D, 27D, 28D, 29D, 30D, 31D and 32D are cross-sectional views taken along lines d-d in FIGS. 26A, 27A, 28A, 29A, 30A, 31A and 32A. Common features with the method for manufacturing the coil component 1A will be omitted as appropriate in the description below.

As illustrated in FIG. 24, the method for manufacturing the coil component 1B includes a conductive paste forming step S40, a base layer forming step S41, a curing pattern forming step S42, an insulating layer forming step S43, a curing pattern forming step S44, an insulating layer forming step S45, a curing pattern forming step S46, a developing step S47, an adding step S48, a grinding step S49, a cutting step S50, a releasing step S51, and a firing step S52. Steps S40 to S52 are performed in that order.

As illustrated in FIGS. 25A and 25B, the conductive paste forming step S40 is a step of forming a conductive paste 18 to be the terminal electrode 3B and a conductive paste 19 to be the terminal electrode 4B on the substrate 11. A release layer 12 is formed on the substrate 11 in advance. The conductive pastes 18, 19 are formed, for example, by applying a conductive paste on the release layer 12 by screen printing.

As illustrated in FIGS. 25C and 25D, the base layer forming step S41 is a step of forming the base layer 13 on the substrate 11. The base layer 13 is formed so as to cover the release layer 12 and the conductive pastes 18, 19. The base layer 13 is formed so as to expose a portion of each of the conductive pastes 18, 19. In this embodiment, the release layer 12 also need not be provided if the base layer 13 can be released from the substrate 11 by physical force.

As illustrated in FIGS. 26A, 26B, 26C and 26D, the curing pattern forming step S42 is a step of applying (e.g., coating) the photosensitive conductive paste 14a on the substrate 11, and exposing the photosensitive conductive paste 14a to light with a pattern corresponding to the coil conductor 5Ba and the connecting conductors 7B, 8B to form a curing pattern 15Ba. The curing pattern 15Ba is the pattern to be the coil conductor 5Ba and the connecting conductors 7B, 8B. As illustrated in FIG. 26B, the curing pattern 15Ba is formed to be directly connected to the portions of the conductive pastes 18, 19 on which the base layer 13 is not provided.

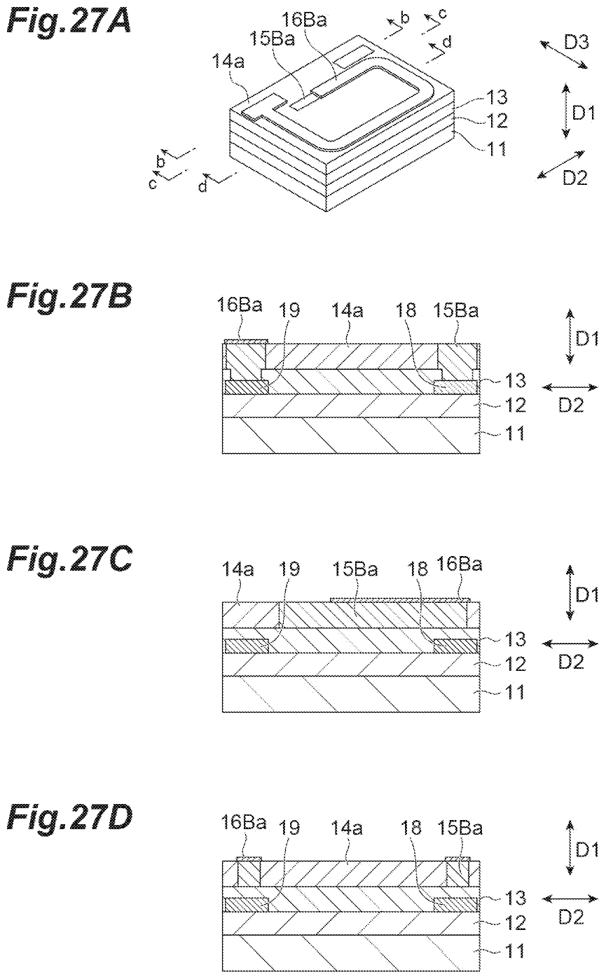

As illustrated in FIGS. 27A, 27B, 27C and 27D, the insulating layer forming step S43 is a step of forming an insulating layer 16Ba on the curing pattern 15Ba. The insulating layer 16Ba is the layer to be the insulating layer 6Ba. The insulating layer 16Ba has a shape that covers the curing pattern 15Ba. The insulating layer 16Ba is not provided on the portion of the curing pattern 15Ba to be the other end part of the coil conductor 5Ba to be connected to the coil conductor 5Bb, or the portion to be the connecting conductor 7B.

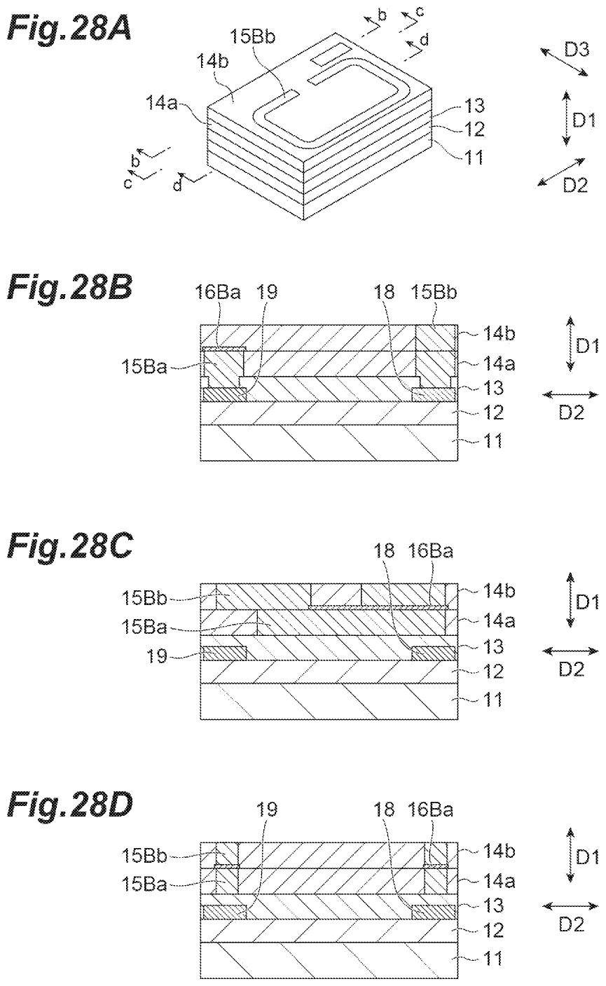

As illustrated in FIGS. 28A, 28B, 28C and 28D, the curing pattern forming step S44 is a step of applying (e.g., coating) the photosensitive conductive paste 14b on the photosensitive conductive paste 14a and the insulating layer 16Ba, and exposing the photosensitive conductive paste 14b to light with a pattern corresponding to the coil conductor 5Bb and the connecting conductor 7B to form a curing pattern 15Bb. The curing pattern 15Bb is the pattern to be the coil conductor 5Bb and the connecting conductor 7B. As illustrated in FIGS. 28B and 28C, the curing pattern 15Bb is formed to be directly connected to the portions of the curing pattern 15Ba on which the insulating layer 16Ba is not provided.

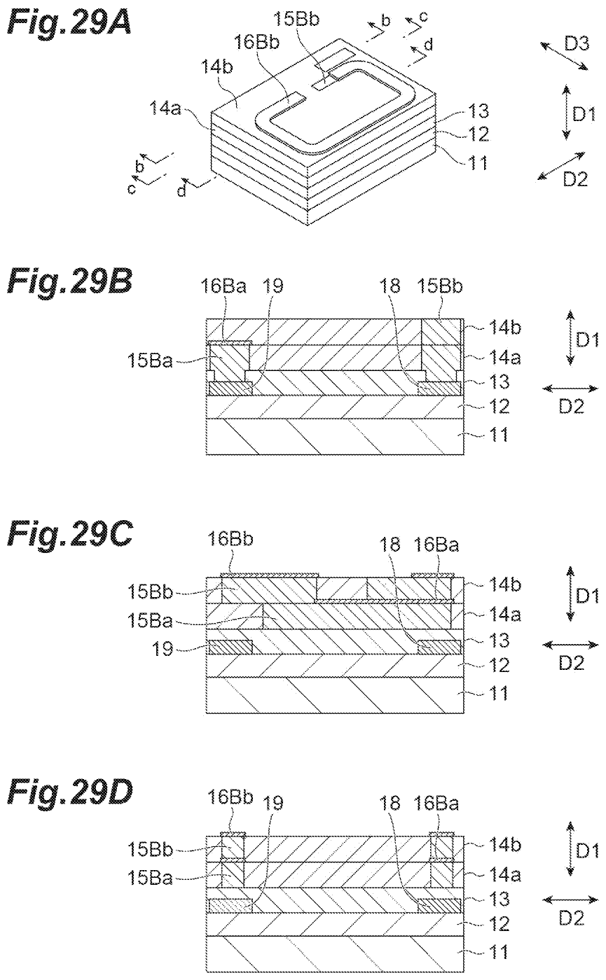

As illustrated in FIGS. 29A, 29B, 29C and 29D, the insulating layer forming step S45 is a step of forming an insulating layer 16Bb on the curing pattern 15Bb. The insulating layer 16Bb is the layer to be the insulating layer 6Bb. The insulating layer 16Bb has a shape that covers the curing pattern 15Bb. The insulating layer 16Bb is not provided on the portion of the curing pattern 15Bb to be the other end part of the coil conductor 5Bb to be connected to the coil conductor 5Bc, or the portion to be the connecting conductor 7B.

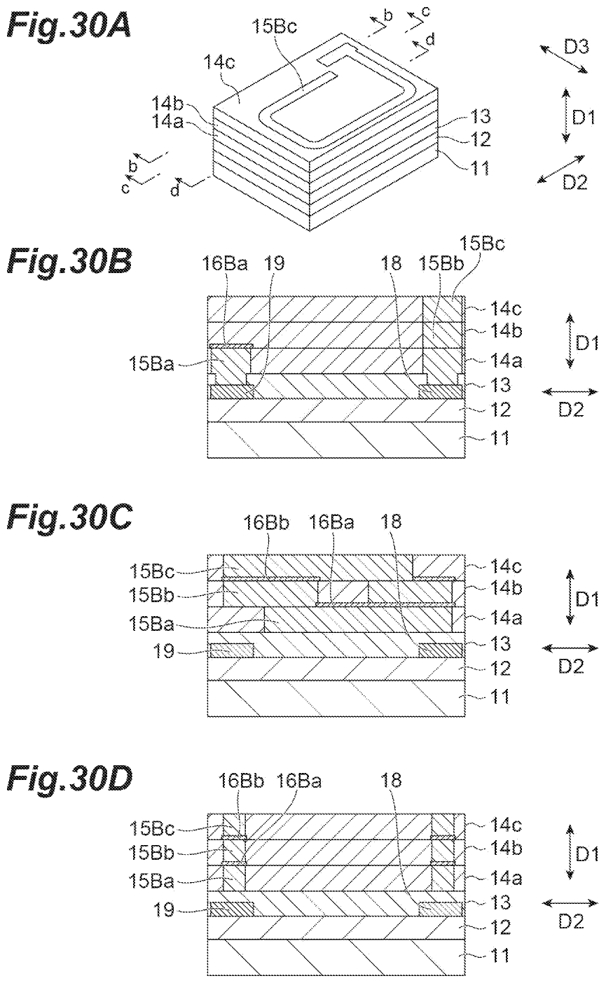

As illustrated in FIGS. 30A, 30B, 30C and 30D, the curing pattern forming step S46 is a step of applying (e.g., coating) the photosensitive conductive paste 14c on the photosensitive conductive paste 14b and the insulating layer 16Bb, and exposing the photosensitive conductive paste 14c to light with a pattern corresponding to the coil conductor 5Bc and the connecting conductor 7B to form a curing pattern 15Bc. The curing pattern 15Bc is the pattern to be the coil conductor 5Bc and the connecting conductor 7B. As illustrated in FIGS. 30B and 30C, the curing pattern 15Bc is formed to be directly connected to the portions of the curing pattern 15Bb on which the insulating layer 16Bb is not provided.

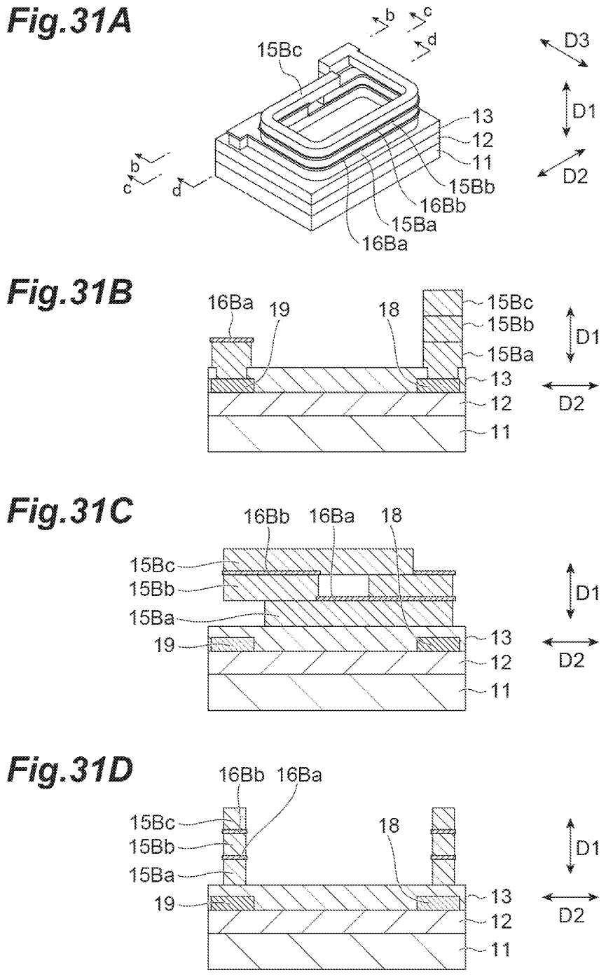

As illustrated in FIGS. 31A, 31B, 31C and 31D, the developing step S47 is a step of developing the portions of the photosensitive conductive pastes 14a, 14b, 14c that were not exposed with a developer. This causes the curing patterns 15Ba, 15Bb, 15Bc and the insulating layers 16Ba, 16Bb to remain on the base layer 13.

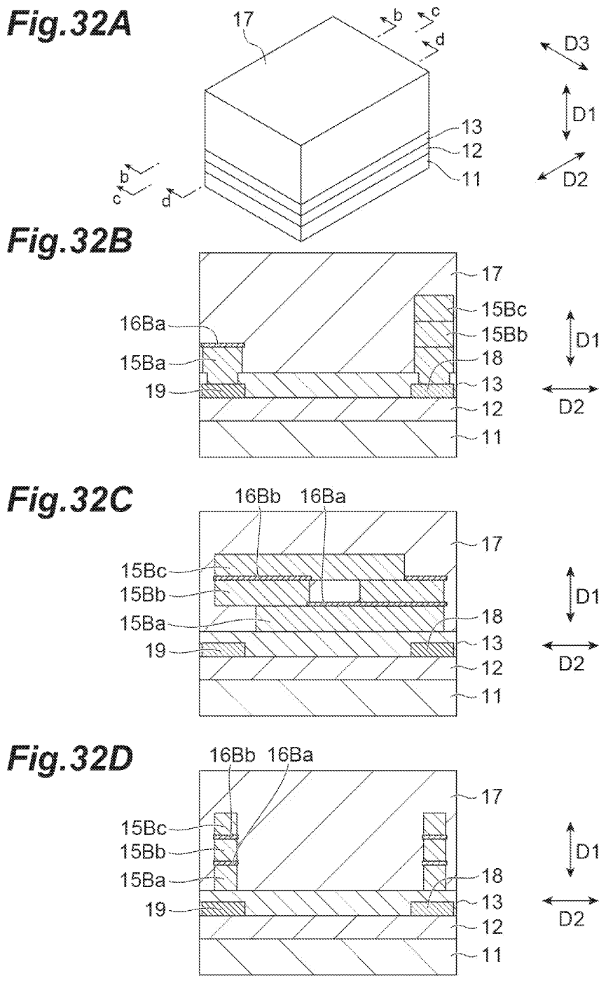

As illustrated in FIGS. 32A, 32B, 32C and 32D, the adding step S48 is a step of adding the insulating material 17 on the substrate 11. The insulating material 17 is added around the curing patterns 15Ba, 15Bb, 15Bc and the insulating layers 16Ba, 16Bb without any gaps. In this embodiment, the insulating material 17 is cured by drying.

The grinding step S49 is a step of grinding the upper surface of the insulating material 17 to adjust the thickness (film thickness) of the insulating material 17 on the curing pattern 15Bc.

The cutting step S50 is a step of cutting an intermediate product obtained in the grinding step S49. Although only the portion corresponding to one coil component 1B is illustrated in FIGS. 25A to 32D, in practice, a plurality of portions corresponding to a plurality of the coil components 1B are arranged in the second direction D2 and the third direction D3 and integrally formed. The cutting step S50 is a step of singulating the plurality of these portions.

The releasing step S51 is a step of releasing the substrate 11 from the base layer 13. The substrate 11 is released from the base layer 13 together with the release layer 12.

The firing step S52 is a step of firing the conductive pastes 18, 19, the base layer 13, the curing patterns 15Ba, 15Bb, 15Bc, the insulating layers 16Ba, 16Bb, and the insulating material 17. The conductive pastes 18, 19 thus become the terminal electrodes 3B, 4B. The base layer 13 becomes the base layer 9. The curing patterns 15Ba, 15Bb, 15Bc become the coil conductors 5Ba, 5Bb, 5Bc and the connecting conductors 7B, 8B. The insulating layers 16Ba, 16Bb become the insulating layers 6Ba, 6Bb. The insulating material 17 becomes the filler 10. The coil component 1B is thus obtained.

Similarly, in the method for manufacturing the coil component 1B as described above, the photosensitive conductive pastes 14a, 14b, 14c are exposed to light and the curing patterns 15Ba, 15Bb, 15Bc are formed in the curing pattern forming steps S42, S44, S46, respectively, and then the portions of the photosensitive conductive pastes 14a, 14b, 14c that were not exposed are developed together in the developing step S47. Thus, the increase in the number of steps can be suppressed while keeping the forming surfaces flat. The number of steps can also be reduced compared to conventional methods which repeat light exposure and developing.

In the method for manufacturing the coil component 1B, the firing step S52 is performed after the adding step S48. This enables a material that exhibits magnetism by firing such as ferrite to be used as the insulating material 17 to be added.

The method for manufacturing the coil component 1B includes, before the developing step S47, the conductive paste forming step S40 in which the conductive pastes 18, 19 to be the terminal electrodes 3B, 4B to be connected to the coil 5B are formed on the substrate 11. The terminal electrodes 3B, 4B can thus be formed together with the coil 5B. The number of steps can further be reduced, since the need to form the terminal electrodes 3B, 4B after forming the coil 5B is eliminated.

### Fourth Embodiment

### (Coil Component)

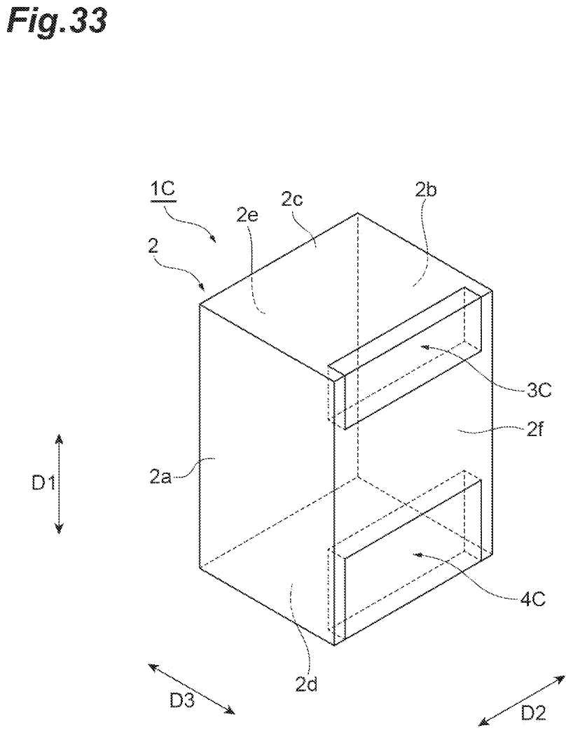

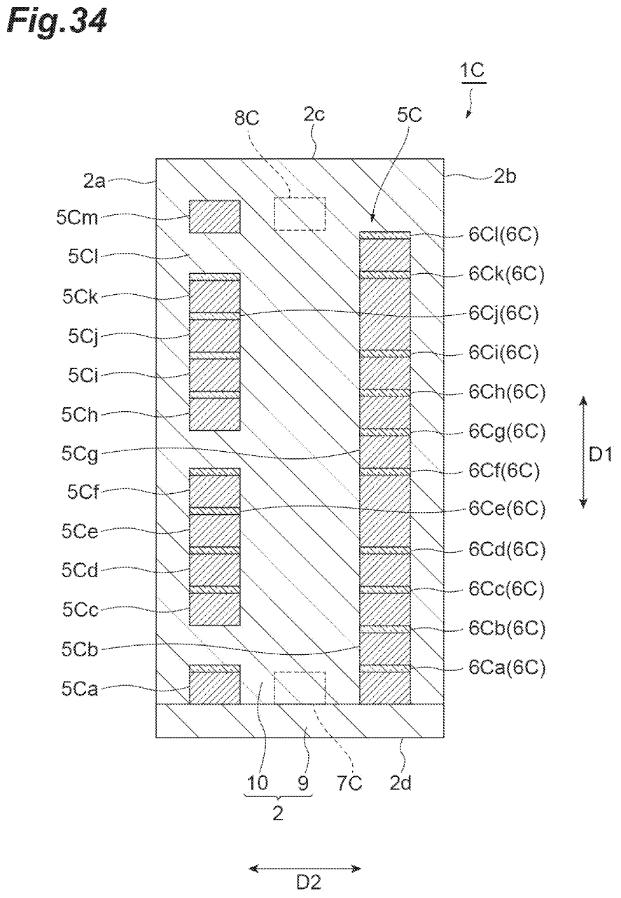

A coil component according to a fourth embodiment will be described with reference to FIGS. 33 and 34. FIG. 33 is a perspective view of the coil component according to the fourth embodiment. FIG. 34 is a diagram illustrating a cross-sectional configuration of the coil component shown in FIG. 33. As illustrated in FIGS. 33 and 34, a coil component 1C includes the element body 2, terminal electrodes 3C, 4C, a coil 5C, an insulating layer(s) 6C, and connecting conductors 7C, 8C. Common features with the coil component 1 will be omitted as appropriate in the description below.

In this embodiment, the side surface 2f is the mounting surface. The length of the element body 2 in the first direction D1 is greater than the length of the element body 2 in the second direction D2 and the length of the element body 2 in the third direction D3. The length of the element body 2 in the second direction D2 and the length of the element body 2 in the third direction D3 are, for example, equal. That is, in this embodiment, the side surfaces 2c, 2d have a square shape, and the side surfaces 2a, 2b, 2e, 2f have a rectangular shape. The length of the element body 2 in the first direction D1 may be equal to or less than the length of the element body 2 in the second direction D2 and the length of the element body 2 in the third direction D3. The length of the element body 2 in the second direction D2 and the length of the element body 2 in the third direction D3 may be different from each other.

The terminal electrodes 3C, 4C are disposed on the side surface 2f spaced from each other in the first direction D1. The terminal electrode 3C is also disposed on the side surface 2c. The terminal electrode 4C is also disposed on the side surface 2d. The terminal electrodes 3C, 4C are disposed spaced from the side surfaces 2a, 2b, 2e. The terminal electrodes 3C, 4C are disposed in recessed parts formed in the side surface 2f. The recessed part in which the terminal electrode 3C is provided reaches the ridge line part between the side surface 2f and the side surface 2c. The terminal electrode 3C is embedded in the element body 2 so as to be exposed on the side surfaces 2f, 2c. Surfaces of the terminal electrode 3C are substantially flush with the side surfaces 2f, 2c. The recessed part in which the terminal electrode 4C is provided reaches the ridge line part between the side surface 2f and the side surface 2d. Surfaces of the terminal electrode 4C are substantially flush with the side surfaces 2f, 2d. The terminal electrodes 3C, 4C have a substantially rectangular shape with the second direction D2 being the long side direction when viewed in the third direction D3.

The terminal electrodes 3C, 4C include a plurality of terminal electrode layers (not shown) which are stacked in the first direction D1. The plurality of terminal electrode layers are integrated such that the boundaries between the layers are not visible. The terminal electrodes 3C, 4C are formed, for example, of the same material as that of the coil 5C.

The coil 5C is disposed inside the element body 2. The coil 5C is spaced from the side surfaces 2a, 2b, 2c, 2d, 2e, 2f of the element body 2, and is not exposed from the element body 2. A coil axis of the coil 5C follows along the first direction D1. The coil 5C includes a plurality of coil conductors 5Ca, 5Cb, 5Cc, 5Cd, 5Ce, 5Cf, 5Cg, 5Ch, 5Ci, 5Cj, 5Ck, 5Cl, 5Cm (hereinafter, “the plurality of coil conductors of the coil 5C”) which are electrically connected to each other. The plurality of coil conductors of the coil 5C are stacked in that order in the first direction D1 on the base layer 9.

Each pair among the plurality of coil conductors of the coil 5C that are adjacent to each other in the stacking direction (first direction D1) have different shapes from each other. Each pair among the plurality of coil conductors of the coil 5C that are adjacent to each other in the stacking direction are stacked such that at least a portion of the pair overlap each other. The coil conductor 5Ca includes one end of the coil 5C. The coil conductor 5Cm includes the other end of the coil 5C.

The coil conductor 5Ca is disposed on the base layer 9 in contact with the base layer 9. One end of the coil conductor 5Ca that forms the one end of the coil 5C is connected to the terminal electrode 4C by the connecting conductor 7C. Each pair among the plurality of coil conductors of the coil 5C that are adjacent to each other in the stacking direction are connected to each other at end parts thereof. The other end of the coil conductor 5Cm that forms the other end of the coil 5C is connected to the terminal electrode 3C by the connecting conductor 8C. The plurality of coil conductors of the coil 5C are stacked via the insulating layer(s) 6C.

The shapes of the coil conductors 5Ca, 5Cb, 5Cc, 5Cd, 5Ce are the same as the shapes of the coil conductors 5Cf, 5Cg, 5Ch, 5Ci, 5Cj, respectively. The shapes of the coil conductors 5Ca, 5Cb are also the same as the shapes of the coil conductors 5Ck, 5Cl, respectively.

The insulating layer(s) 6C includes a plurality of insulating layers 6Ca, 6Cb, 6Cc, 6Cd, 6Ce, 6Cf, 6Cg, 6Ch, 6Ci, 6Cj, 6Ck, 6Cl. The insulating layer(s) 6C is disposed between adjacent pairs of the plurality of coil conductors of the coil 5C in the stacking direction (first direction D1). The insulating layer 6Ca is disposed between the coil conductors 5Ca, 5Cb. The insulating layer 6Cb is disposed between the coil conductors 5Cb, 5Cc. The insulating layer 6Cc is disposed between the coil conductors 5Cc, 5Cd. The insulating layer 6Ce is disposed between the coil conductors 5Ce, 5Cf. The insulating layer 6Cf is disposed between the coil conductors 5Cf, 5Cg. The insulating layer 6Cg is disposed between the coil conductors 5Cg, 5Ch. The insulating layer 6Ci is disposed between the coil conductors 5Ci, 5Cj. The insulating layer 6Cj is disposed between the coil conductors 5Cj, 5Ck. The insulating layer 6Ck is disposed between the coil conductors 5Ck, 5Cl. The insulating layer 6Cl is disposed between the coil conductors 5Cl, 5Cm. The insulating layer(s) 6C is formed to have a width that is the same as or greater than the width of the corresponding coil conductors. The insulating layer(s) 6C is not disposed between end parts of the coil conductors adjacent in the stacking direction so as to enable the end parts to be directly connected to each other.

The insulating layer(s) 6C may be formed of the same or different insulating material as that of the element body 2. The insulating layer(s) 6C may be formed of a magnetic or non-magnetic material. The insulating layer(s) 6C may have a single layer structure or a multilayer structure. The insulating layer(s) 6C may have a multilayer structure in which a magnetic layer and a non-magnetic layer are stacked.

The connecting conductor 7C extends in the third direction D3, and is connected to the terminal electrode 4C and the one end of the coil 5C. The connecting conductor 8C extends in the third direction D3, and is connected to the terminal electrode 3C and the other end of the coil 5C. The connecting conductors 7C, 8C are formed, for example, of the same material as that of the plurality of coil conductors of the coil 5C.

### (Method for Manufacturing Coil Component)

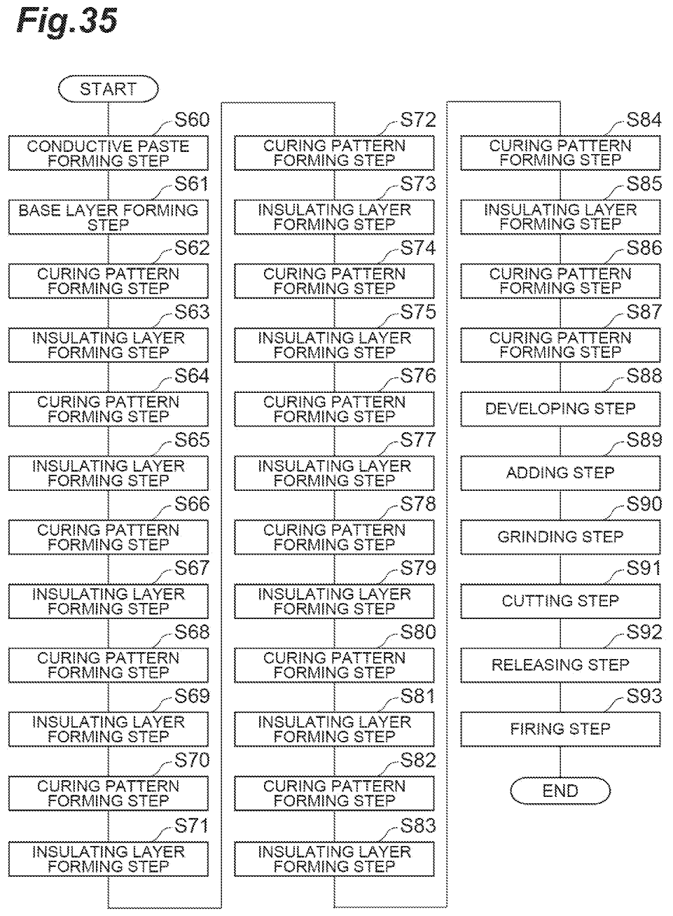

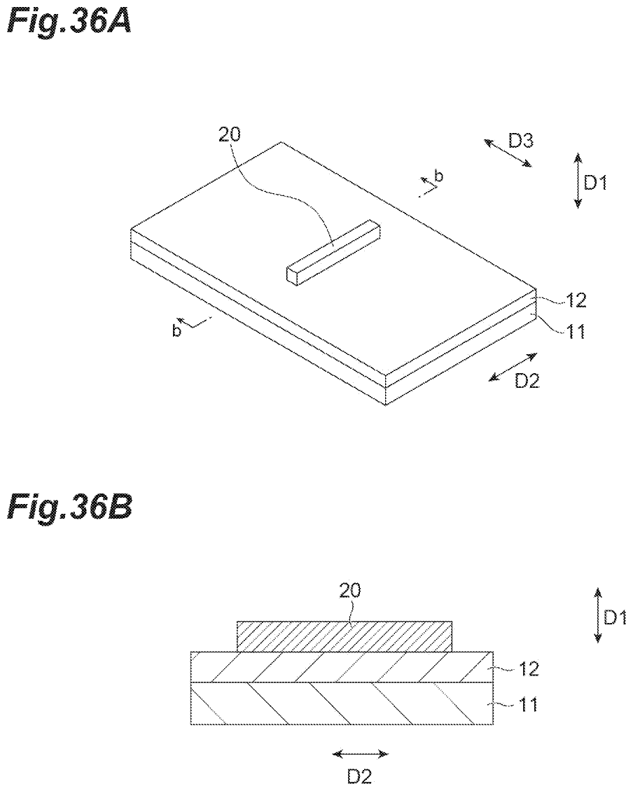

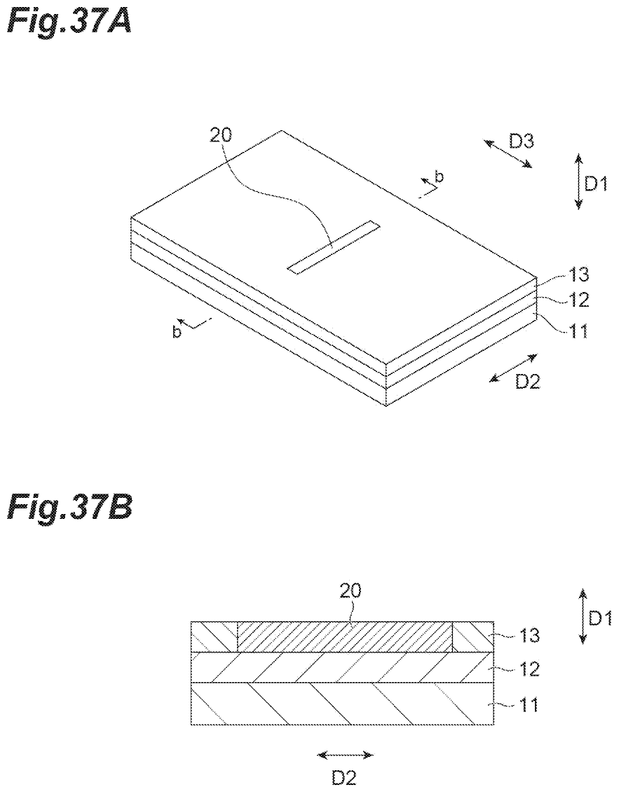

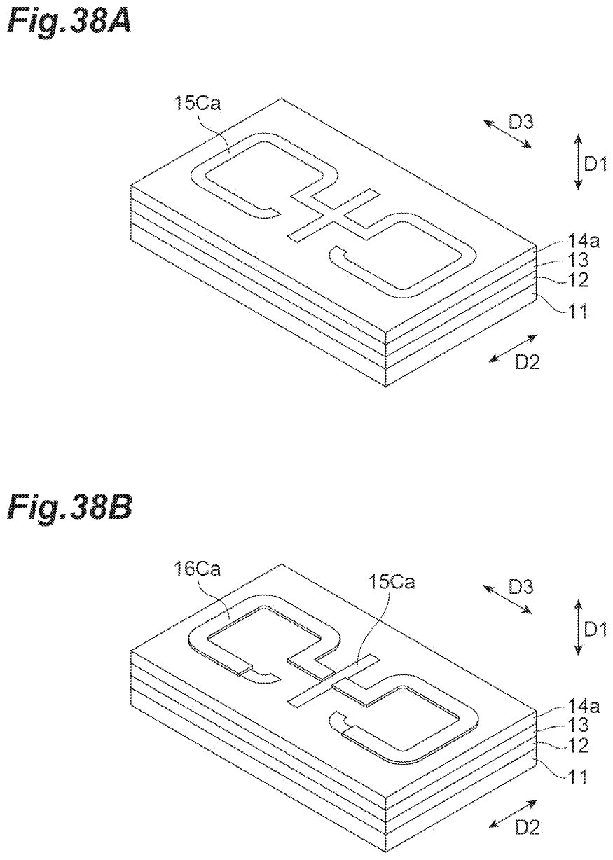

An example of a method for manufacturing the coil component 1C will be described next with reference to FIGS. 35 to 47B. FIG. 35 is a flowchart illustrating a method for manufacturing the coil component of FIG. 33. FIGS. 36A and 37A are perspective views in a manufacturing step, and FIGS. 36B and 37B are cross-sectional views taken along lines b-b in FIGS. 36A and 37A. FIGS. 38A to 47B are perspective views in the manufacturing steps. The coil component 1C is manufactured using photolithography. Common features with the method for manufacturing the coil component 1 will be omitted as appropriate in the description below. In this embodiment, two of the coil components 1C are manufactured at the same time with the mounting surfaces (side surfaces 2f) facing each other.

As illustrated in FIG. 35, the method for manufacturing the coil component 1C includes a conductive paste forming step S60, a base layer forming step S61, a curing pattern forming step S62, an insulating layer forming step S63, a curing pattern forming step S64, an insulating layer forming step S65, a curing pattern forming step S66, an insulating layer forming step S67, a curing pattern forming step S68, an insulating layer forming step S69, a curing pattern forming step S70, an insulating layer forming step S71, a curing pattern forming step S72, an insulating layer forming step S73, a curing pattern forming step S74, an insulating layer forming step S75, a curing pattern forming step S76, an insulating layer forming step S77, a curing pattern forming step S78, an insulating layer forming step S79, a curing pattern forming step S80, an insulating layer forming step S81, a curing pattern forming step S82, an insulating layer forming step S83, a curing pattern forming step S84, an insulating layer forming step S85, a curing pattern forming step S86, a curing pattern forming step S87, a developing step S88, an adding step S89, a grinding step S90, a cutting step S91, a releasing step S92, and a firing step S93. Steps S60 to S93 are performed in that order.

As illustrated in FIGS. 36A and 36B, the conductive paste forming step S60 is a step of forming a conductive paste 20 to be a terminal electrode layer of the terminal electrode 4C on the substrate 11. The release layer 12 is formed on the substrate 11 in advance. The conductive paste 20 is applied on the release layer 12, for example, by screen printing. In this embodiment, the release layer 12 also need not be provided if the base layer 13 (see FIG. 37A) can be released from the substrate 11 by physical force.

As illustrated in FIGS. 37A and 37B, the base layer forming step S61 is a step of forming the base layer 13 on the substrate 11. The base layer 13 is formed around the conductive paste 20 so as to cover the release layer 12. The base layer 13 is formed to be substantially flush with the conductive paste 20.

As illustrated in FIG. 38A, the curing pattern forming step S62 is a step of applying (e.g., coating) the photosensitive conductive paste 14a on the substrate 11, and exposing the photosensitive conductive paste 14a to light with a pattern corresponding to the coil conductor 5Ca, the connecting conductor 7C, and the terminal electrode 4C to form a curing pattern 15Ca. The curing pattern 15Ca is the pattern to be the coil conductor 5Ca, the connecting conductor 7C, and the terminal electrode 4C. The pattern of the curing pattern 15Ca that corresponds to the terminal electrode 4C is formed directly on the conductive paste 20.

As illustrated in FIG. 38B, the insulating layer forming step S63 is a step of forming an insulating layer 16Ca on the curing pattern 15Ca. The insulating layer 16Ca is the layer to be the insulating layer 6Ca. The insulating layer(s) 16C is formed in a manner similar to that of the insulating layer 16. The insulating layer 16Ca has a shape that covers the curing pattern 15Ca. The insulating layer 16Ca is not provided on the portion of the curing pattern 15Ca to be an end part of the coil conductor 5Ca to be connected to the coil conductor 5Cb, or the portion to be the terminal electrode 4C.

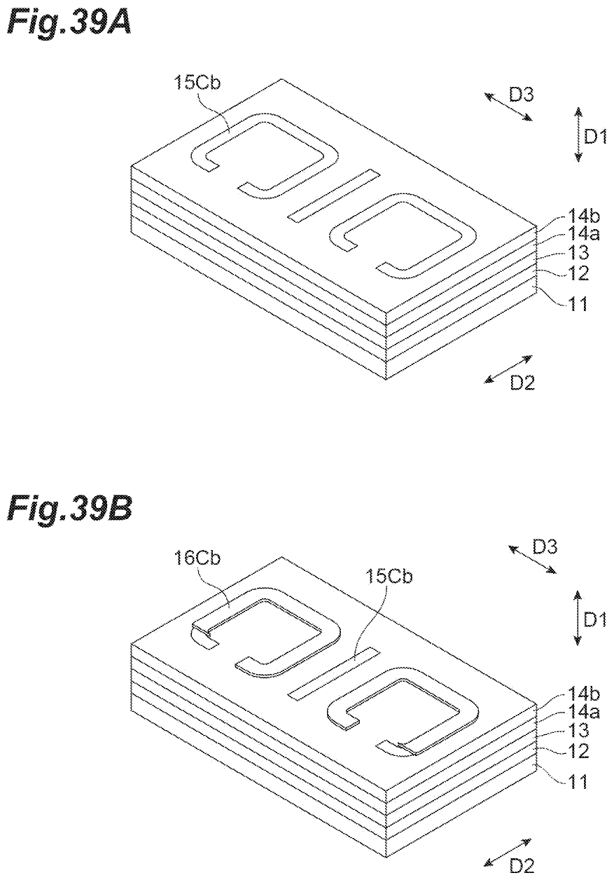

As illustrated in FIG. 39A, the curing pattern forming step S64 is a step of applying (e.g., coating) the photosensitive conductive paste 14b on the photosensitive conductive paste 14a and the insulating layer 16Ca, and exposing the photosensitive conductive paste 14b to light with a pattern corresponding to the coil conductor 5Cb and the terminal electrode 4C to form a curing pattern 15Cb. The curing pattern 15Cb is the pattern to be the coil conductor 5Cb and the terminal electrode 4C. The curing pattern 15Cb is formed to be directly connected to the portion of the curing pattern 15Ca on which the insulating layer 16Ca is not provided.

As illustrated in FIG. 39B, the insulating layer forming step S65 is a step of forming an insulating layer 16Cb on the curing pattern 15Cb. The insulating layer 16Cb is the layer to be the insulating layer 6Cb. The insulating layer 16Cb has a shape that covers the curing pattern 15Cb. The insulating layer 16Cb is not provided on the portion of the curing pattern 15Cb to be the other end part of the coil conductor 5Cb to be connected to the coil conductor 5Cc, or the portion to be the terminal electrode 4C.

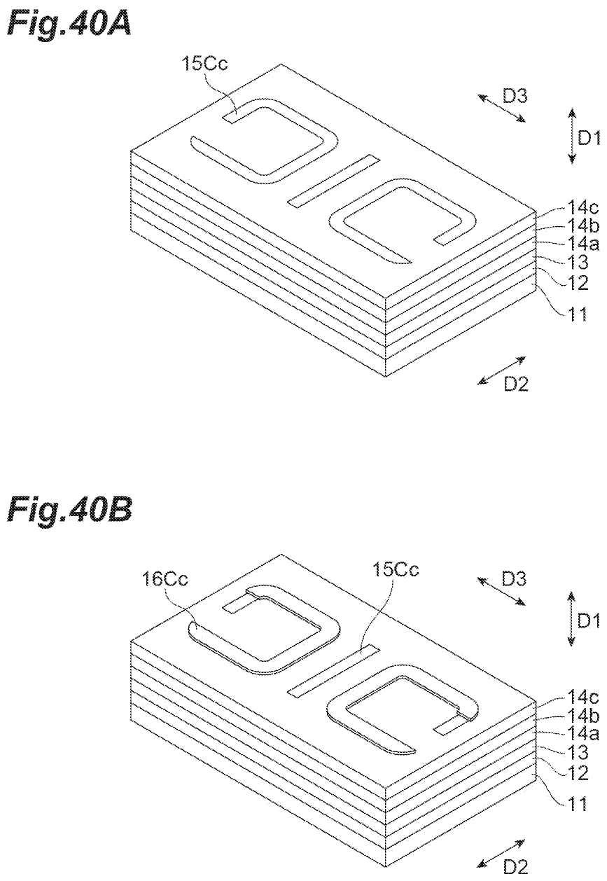

As illustrated in FIG. 40A, the curing pattern forming step S66 is a step of applying (e.g., coating) the photosensitive conductive paste 14c on the photosensitive conductive paste 14b and the insulating layer 16Cb, and exposing the photosensitive conductive paste 14c to light with a pattern corresponding to the coil conductor 5Cc and the terminal electrode 4C to form a curing pattern 15Cc. The curing pattern 15Cc is the pattern to be the coil conductor 5Cc and the terminal electrode 4C. The curing pattern 15Cc is formed to be directly connected to the portion of the curing pattern 15Cb on which the insulating layer 16Cb is not provided.

As illustrated in FIG. 40B, the insulating layer forming step S67 is a step of forming an insulating layer 16Cc on the curing pattern 15Cc. The insulating layer 16Cc is the layer to be the insulating layer 6Cc. The insulating layer 16Cc has a shape that covers the curing pattern 15Cc. The insulating layer 16Cc is not provided on the portion of the curing pattern 15Cc to be the other end part of the coil conductor 5Cc to be connected to the coil conductor 5Cd, or the portion to be the terminal electrode 4C.

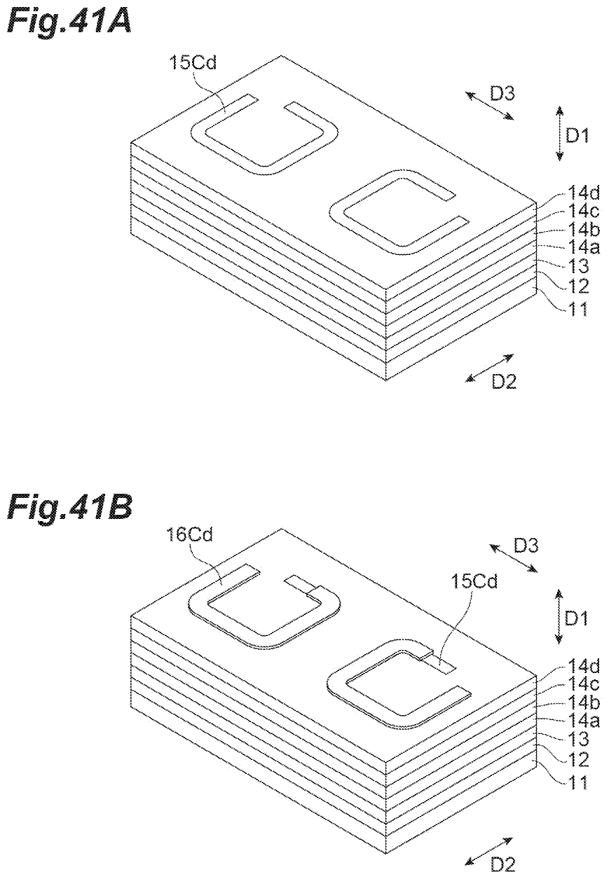

As illustrated in FIG. 41A, the curing pattern forming step S68 is a step of applying (e.g., coating) a photosensitive conductive paste 14d on the photosensitive conductive paste 14c and the insulating layer 16Cc, and exposing the photosensitive conductive paste 14d to light with a pattern corresponding to the coil conductor 5Cd to form a curing pattern 15Cd. The curing pattern 15Cd is the pattern to be the coil conductor 5Cd. The curing pattern 15Cd is formed to be directly connected to the portion of the curing pattern 15Cc on which the insulating layer 16Cc is not provided.

As illustrated in FIG. 41B, the insulating layer forming step S69 is a step of forming an insulating layer 16Cd on the curing pattern 15Cd. The insulating layer 16Cd is the layer to be the insulating layer 6Cd. The insulating layer 16Cd has a shape that covers the curing pattern 15Cd. The insulating layer 16Cd is not provided on the portion of the curing pattern 15Cd to be the other end part of the coil conductor 5Cd to be connected to the coil conductor SCe.

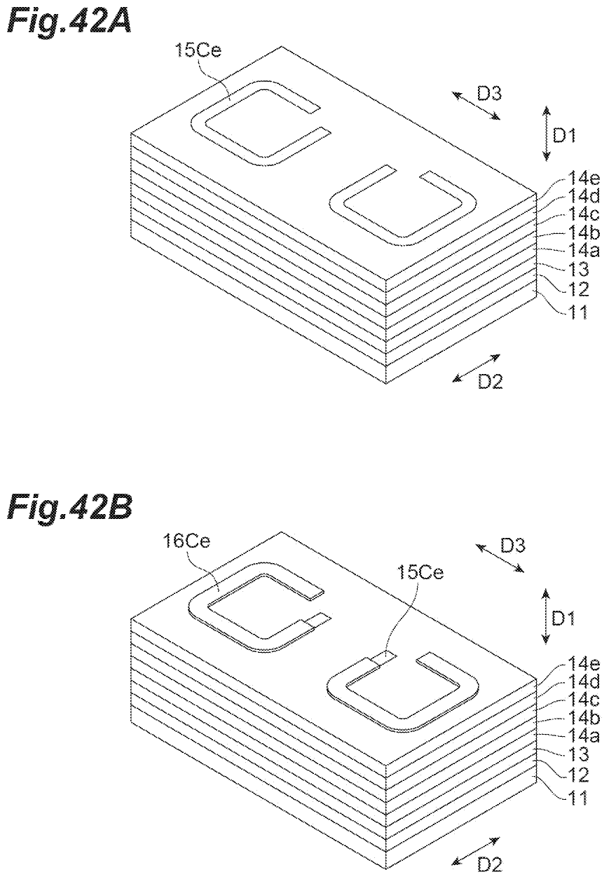

As illustrated in FIG. 42A, the curing pattern forming step S70 is a step of applying (e.g., coating) a photosensitive conductive paste 14e on the photosensitive conductive paste 14d and the insulating layer 16Cd, and exposing the photosensitive conductive paste 14e to light with a pattern corresponding to the coil conductor 5Ce to form a curing pattern 15Ce. The curing pattern 15Ce is the pattern to be the coil conductor 5Ce. The curing pattern 15Ce is formed to be directly connected to the portion of the curing pattern 15Cd on which the insulating layer 16Cd is not provided.

As illustrated in FIG. 42B, the insulating layer forming step S71 is a step of forming an insulating layer 16Ce on the curing pattern 15Ce. The insulating layer 16Ce is the layer to be the insulating layer 6Ce. The insulating layer 16Ce has a shape that covers the curing pattern 15Ce. The insulating layer 16Ce is not provided on the portion of the curing pattern 15Ce to be the other end part of the coil conductor 5Ce to be connected to the coil conductor 5Cf.

The curing pattern forming step S72 is a step of forming a curing pattern to be the coil conductor 5Cf. The insulating layer forming step S73 is a step of forming an insulating layer to be the insulating layer 6Cf. The curing pattern forming step S74 is a step of forming the curing pattern to be the coil conductor 5Cg. The insulating layer forming step S75 is a step of forming the insulating layer to be the insulating layer 6Cg. The curing pattern forming step S76 is a step of forming the curing pattern to be the coil conductor 5Ch. The insulating layer forming step S77 is a step of forming the insulating layer to be the insulating layer 6Ch. The curing pattern forming step S78 is a step of forming the curing pattern to be the coil conductor 5Ci. The insulating layer forming step S79 is a step of forming the insulating layer to be the insulating layer 6Ci. The curing pattern forming step S80 is a step of forming the curing pattern to be the coil conductor 5Cj. The insulating layer forming step S81 is a step of forming the insulating layer to be the insulating layer 6Cj.

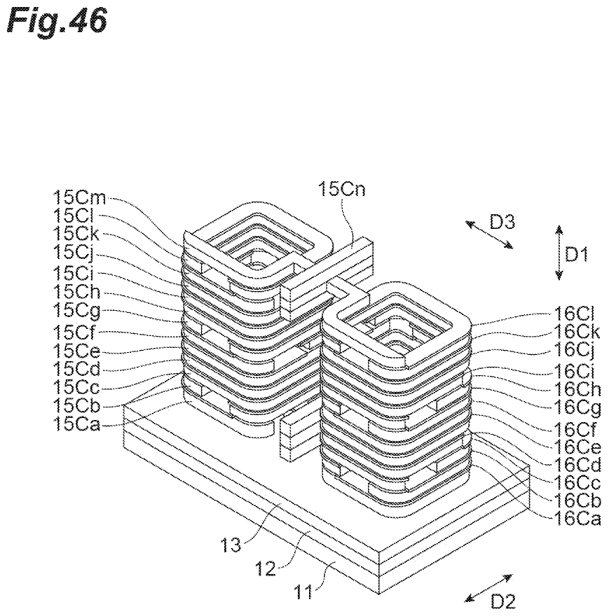

As mentioned above, the shapes of the coil conductors 5Ca, 5Cb, 5Cc, 5Cd, 5Ce are the same as the shapes of the coil conductors 5Cf, 5Cg, 5Ch, 5Ci, 5Cj, respectively. Thus, illustration and description of steps S72 to S81 for forming the curing patterns 15Cf, 15Cg, 15Ch, 15Ci, 15Cj (see FIG. 46) to be the coil conductors 5Cf, 5Cg, 5Ch, 5Ci, 5Cj, and the insulating layers 16Cf, 16Cg, 16Ch, 16Ci, 16Cj (see FIG. 46) to be the insulating layers 6Cf, 6Cg, 6Ch, 6Ci, 6Cj will be omitted.

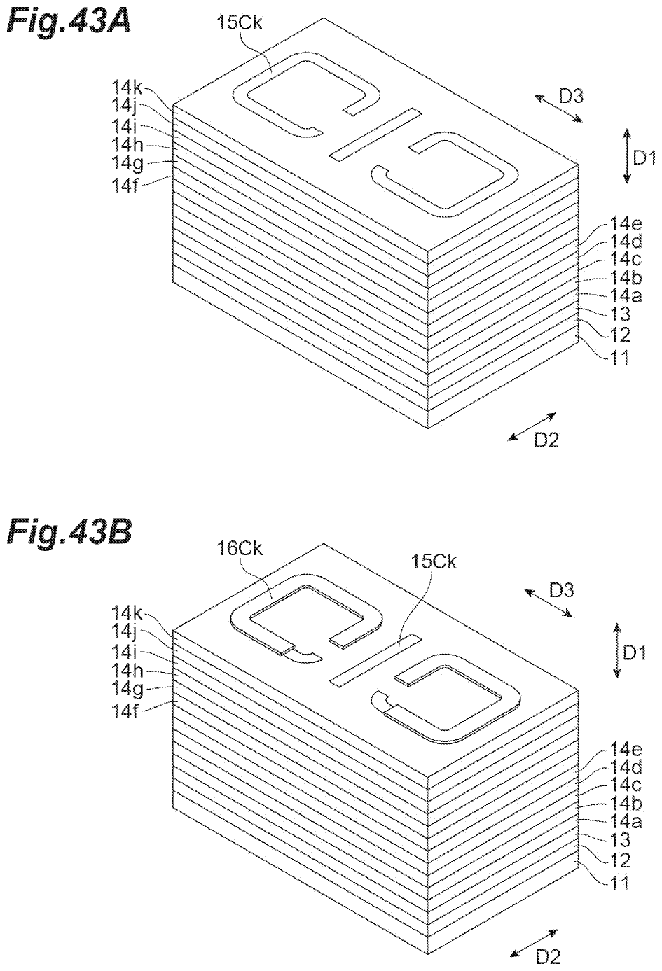

As illustrated in FIG. 43A, the curing pattern forming step S82 is a step of applying (e.g., coating) a photosensitive conductive paste 14k on a photosensitive conductive paste 14j and the insulating layer 16Cj, and exposing the photosensitive conductive paste 14k to light with a pattern corresponding to the coil conductor 5Ck and the terminal electrode 3C to form a curing pattern 15Ck. The curing pattern 15Ck is the pattern to be the coil conductor 5Ck and the terminal electrode 3C. The curing pattern 15Ck is formed to be directly connected to the portion of the curing pattern 15Cj on which the insulating layer 16Cj is not provided.

As illustrated in FIG. 43B, the insulating layer forming step S83 is a step of forming an insulating layer 16Ck on the curing pattern 15Ck. The insulating layer 16Ck is the layer to be the insulating layer 6Ck. The insulating layer 16Ck has a shape that covers the curing pattern 15Ck. The insulating layer 16Ck is not provided on the portion of the curing pattern 15Ck to be the other end part of the coil conductor 5Ck to be connected to the coil conductor 5Cl, or the portion to be the terminal electrode 3C.

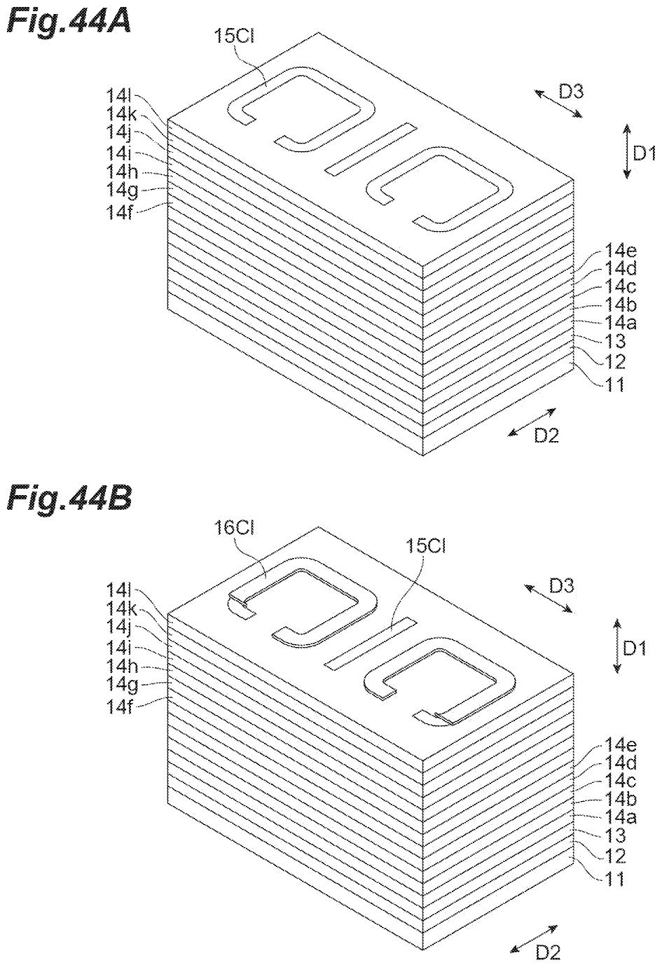

As illustrated in FIG. 44A, the curing pattern forming step S84 is a step of applying (e.g., coating) a photosensitive conductive paste 14l on the photosensitive conductive paste 14k and the insulating layer 16Ck, and exposing the photosensitive conductive paste 14l to light with a pattern corresponding to the coil conductor 5Cl and the terminal electrode 3C to form a curing pattern 15Cl. The curing pattern 15Cl is the pattern to be the coil conductor 5Cl and the terminal electrode 3C. The curing pattern 15Cl is formed to be directly connected to the portion of the curing pattern 15Ck on which the insulating layer 16Ck is not provided.

As illustrated in FIG. 44B, the insulating layer forming step S85 is a step of forming an insulating layer 16Cl on the curing pattern 15Cl. The insulating layer 16Cl is the layer to be the insulating layer 6Cl. The insulating layer 16Cl has a shape that covers the curing pattern 15Cl. The insulating layer 16Cl is not provided on the portion of the curing pattern 15Cl to be the other end part of the coil conductor 5Cl to be connected to the coil conductor 5Cm, or the portion to be the terminal electrode 3C.

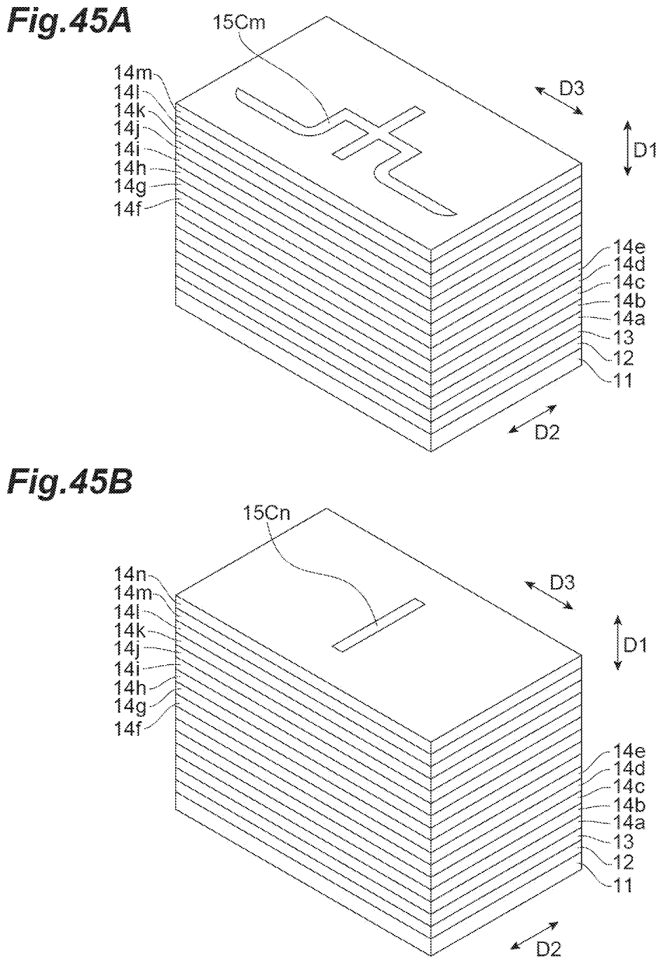

As illustrated in FIG. 45A, the curing pattern forming step S86 is a step of applying (e.g., coating) a photosensitive conductive paste 14m on the photosensitive conductive paste 14l and the insulating layer 16Cl, and exposing the photosensitive conductive paste 14m to light with a pattern corresponding to the coil conductor 5Cm, the connecting conductor 8C, and the terminal electrode 3C to form a curing pattern 15Cm. The curing pattern 15Cm is the pattern to be the coil conductor 5Cm, the connecting conductor 8C, and the terminal electrode 3C. The curing pattern 15Cm is formed to be directly connected to the portion of the curing pattern 15Cl on which the insulating layer 16Cl is not provided.

As illustrated in FIG. 45B, the curing pattern forming step S87 is a step of applying (e.g., coating) a photosensitive conductive paste 14n on the photosensitive conductive paste 14m, and exposing the photosensitive conductive paste 14n to light with a pattern corresponding to the terminal electrode 3C to form a curing pattern 15Cn. The curing pattern 15Cn is the pattern to be the terminal electrode 3C. The curing pattern 15Cn is formed to be directly connected to the portion of the curing pattern 15Cl to be the terminal electrode 3C.

As illustrated in FIG. 46, the developing step S88 is a step of developing the portions of the photosensitive conductive pastes 14a, 14b, 14c, 14d, 14e, 14f, 14g, 14h, 14i, 14j, 14k, 14l, 14m, 14n that were not exposed with a developer. This causes the curing patterns 15Ca, 15Cb, 15Cc, 15Cd, 15Ce, 15Cf, 15Cg, 15Ch, 15Ci, 15Cj, 15Ck, 15Cl, 15Cm, 15Cn (hereinafter, a “plurality of the curing patterns 15C”) and the insulating layers 16Ca, 16Cb, 16Cc, 16Cd, 16Ce, 16Cf, 16Cg, 16Ch, 16Ci, 16Cj, 16Ck, 16Cl (hereinafter, a “plurality of the insulating layers 16C”) to remain on the base layer 13.

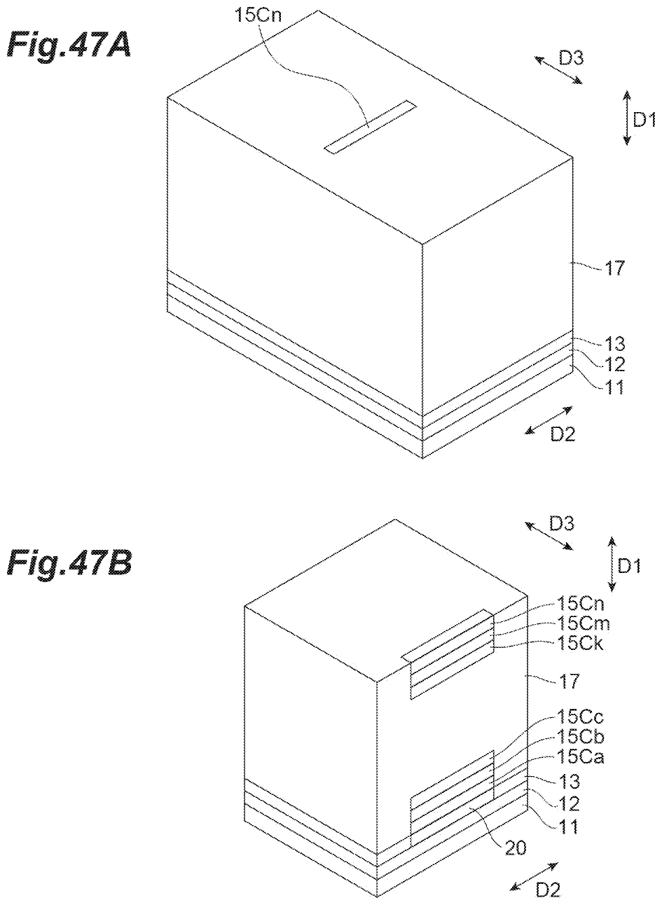

The adding step S89 is a step of adding the insulating material 17 on the substrate 11 (see FIG. 47A). The insulating material 17 is added around the plurality of the curing patterns 15C and the plurality of the insulating layers 16C without any gaps. In this embodiment, the insulating material 17 is cured by drying.

As illustrated in FIG. 47A, the grinding step S90 is a step of grinding the upper surface of the insulating material 17 to expose an upper surface of the curing pattern 15Cn.

As illustrated in FIG. 47B, the cutting step S91 is a step of cutting an intermediate product obtained in the grinding step S90 at the center in the third direction D3. Although only the portion corresponding to two coil components 1C are illustrated in FIGS. 36A to 47B, a plurality of portions corresponding to a larger even number of the coil components 1C may be arranged in the second direction D2 and the third direction D3 and integrally formed. The cutting step S91 is a step of singulating the plurality of these portions.

The releasing step S92 is a step of releasing the substrate 11 from the base layer 13. The substrate 11 is released from the base layer 13 together with the release layer 12.

The firing step S93 is a step of firing the conductive paste 20, the base layer 13, the plurality of the curing patterns 15C, the plurality of the insulating layers 16C, and the insulating material 17. The conductive paste 20 thus becomes a portion of the terminal electrode 4C. The base layer 13 becomes the base layer 9. The plurality of the curing patterns 15C become the remaining portion of the terminal electrode 4C, the terminal electrode 3C, the plurality of coil conductors of the coil 5C, and the connecting conductors 7C, 8C. The plurality of the insulating layers 16C become a plurality of the insulating layers 6C. The insulating material 17 becomes the filler 10. The coil component 1C is thus obtained.

Similarly, in the method for manufacturing the coil component 1C as described above, the plurality of the curing patterns 15C are formed in the curing pattern forming steps, and then the portions of the photosensitive conductive pastes 14a, 14b, 14c, 14d, 14e, 14f, 14g, 14h, 14i, 14j, 14k, 14l, 14m, 14n that were not exposed are developed together in the developing step S88. Thus, the increase in the number of steps can be suppressed while keeping the forming surfaces flat. The number of steps can also be reduced compared to conventional methods which repeat light exposure and developing.

The method for manufacturing the coil component 1C includes, before the developing step S88, the conductive paste forming step S60 in which the conductive paste 20 to be a portion of the terminal electrodes 3C, 4C to be connected to the coil 5C is formed on the substrate 11, and the curing pattern forming steps S62, S64, S66, S84, S86, S87 in which the photosensitive conductive pastes 14a, 14b, 14c, 14k, 14l, 14m, 14n to be the remaining portions of the terminal electrodes 3C, 4C are formed on the substrate 11. The terminal electrodes 3C, 4C can thus be formed together with the coil 5C. The number of steps can further be reduced, since the need to form the terminal electrodes 3C, 4C after forming the coil 5C is eliminated.

### First Variation

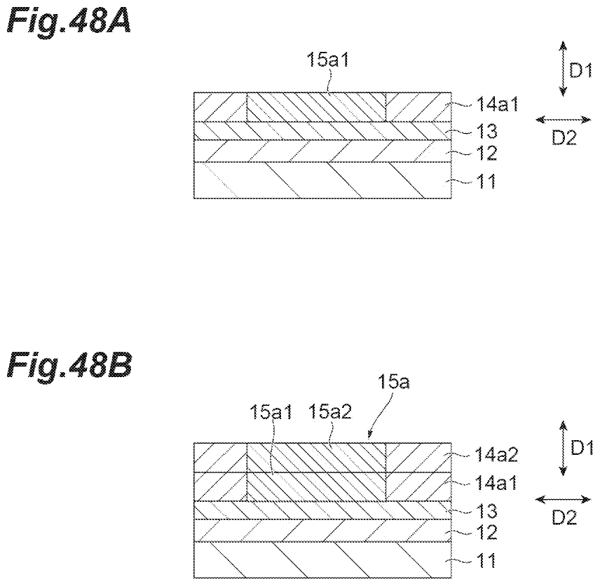

A method for manufacturing a coil component according to a first variation of the first embodiment will be described with reference to FIGS. 48A and 48B. FIGS. 48A and 48B are diagrams illustrating a manufacturing step of the coil component according to the first variation of the first embodiment. This variation is different from the method for manufacturing the coil component 1 according to the first embodiment in that application (e.g., coating) and light exposure of the photosensitive conductive paste 14a are repeated in the curing pattern forming step S2 (see FIG. 3) to form a single curing pattern 15a. Specifically, as illustrated in FIG. 48A, in the curing pattern forming step S2, a photosensitive conductive paste 14a1 is applied on the base layer 13, and the photosensitive conductive paste 14a1 is exposed to light with a pattern corresponding to the coil conductor 5a and the connecting conductor 7 to form a curing pattern 15a1. Then, as illustrated in FIG. 48B, a photosensitive conductive paste 14a2 is applied on the photosensitive conductive paste 14a1 without developing, and the photosensitive conductive paste 14a2 is exposed to light with a pattern corresponding to the coil conductor 5a and the connecting conductor 7 to form a curing pattern 15a2. The curing patterns 15a1, 15a2 have the same shape.

The curing pattern 15a is composed of a plurality of the curing patterns 15a1, 15a2. Although in this example, application and light exposure of the photosensitive conductive paste 14a are repeated twice so that the curing pattern 15a has a double layer structure, there may be three or more layers. Although illustration is omitted, application and light exposure of the photosensitive conductive pastes 14b, 14c are performed similarly for the curing patterns 15b, 15c. This variation is capable of forming the coil conductors 5a, 5b, 5c at a high aspect ratio, while keeping the forming surfaces flat and reducing the number of steps.

### Second Variation

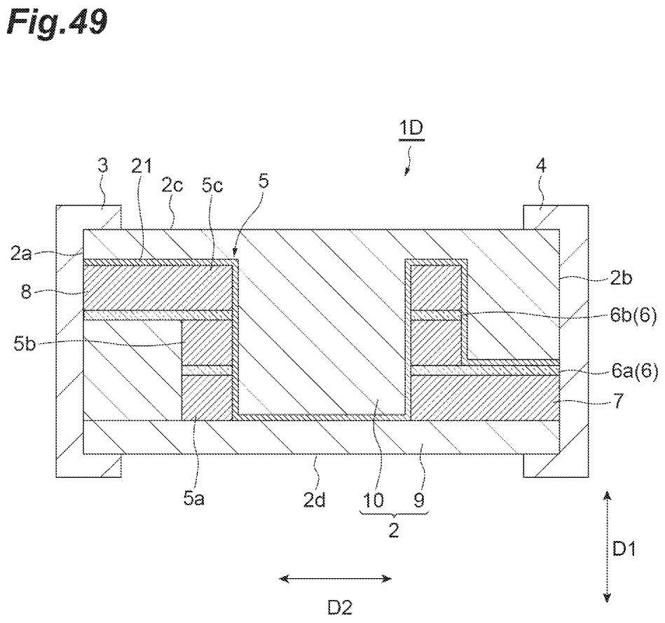

A method for manufacturing a coil component according to a second variation of the first embodiment will be described with reference to FIG. 49. FIG. 49 is a diagram illustrating a cross-sectional configuration of the coil component according to the second variation of the first embodiment. As illustrated in FIG. 49, a coil component 1D according to this variation is different from the coil component 1 in that the coil component 1D further includes an insulating film 21 that covers the coil 5. The insulating film 21 is provided inside the element body 2. The insulating film 21 has electrical insulating properties. The insulating film 21 includes, for example, glass, ferrite, or non-magnetic materials such as SiO₂, Al₂O₃, and ZrO₂. The insulating film 21 covers at least a portion of the coil 5. The insulating film 21 may cover the entirety of the coil 5 other than the ends thereof to be connected to the terminal electrodes 3, 4. Providing the insulating film 21 in addition to the insulating layer 6 further improves the insulating properties of the coil 5 and the connecting conductors 7, 8.

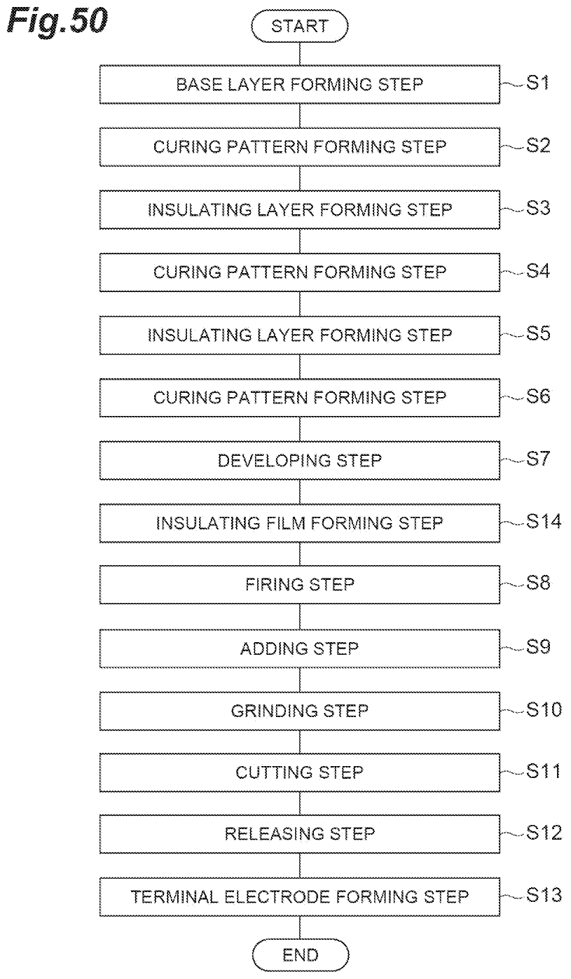

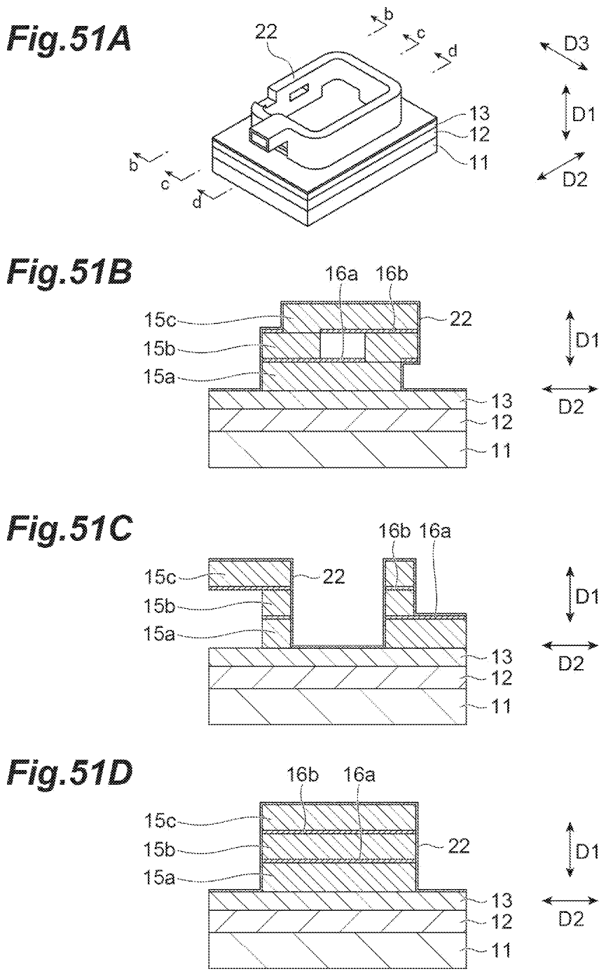

A method for manufacturing the coil component 1D in which the insulating film 21 includes a material that is sintered alone will be described with reference to FIGS. 50 and 51. Materials that are sintered alone specifically include glass, ferrite, and the like. FIG. 50 is a flowchart illustrating a method for manufacturing the coil component of FIG. 49. FIG. 51 are diagrams illustrating a manufacturing step of the coil component of FIG. 49. As illustrated in FIG. 50, the method for manufacturing the coil component 1D is different from the method for manufacturing the coil component 1 in that it includes an insulating film forming step S14. The insulating film forming step S14 is performed between the developing step S7 and the firing step S8.

As illustrated in FIGS. 51A, 51B, 51C and 51D, the insulating film forming step S14 in this case is a step of forming an insulating film 22 to be the insulating film 21 so as to cover the base layer 13, the curing patterns 15a, 15b, 15c, and the insulating layers 16a, 16b that remain after developing. The insulating film 22 is applied as a coating including glass or ferrite, for example, by a spray coater. The insulating film 22 becomes the insulating film 21 by being fired in the firing step S8.

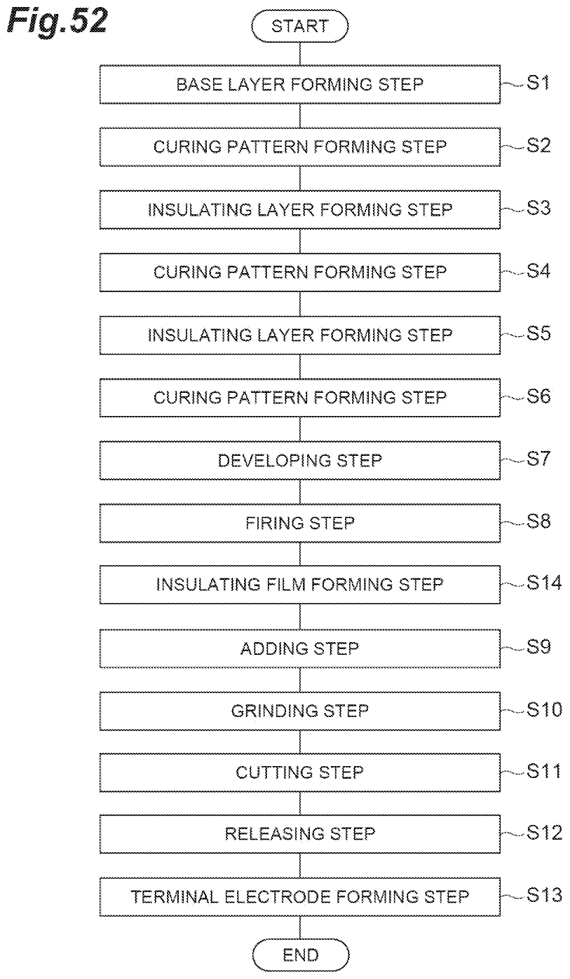

A method for manufacturing the coil component 1D in which the insulating film 21 includes a material that is not sintered alone will be described with reference to FIG. 52. Materials that is not sintered alone specifically include non-magnetic materials such as SiO₂, Al₂O₃, and ZrO₂. FIG. 52 is a flowchart illustrating another method for manufacturing the coil component of FIG. 49. As illustrated in FIG. 52, the other method for manufacturing the coil component 1D is different from the manufacturing method above in that the insulating film forming step S14 is performed between the developing step S7 and the firing step S8.

Although illustration is omitted, the insulating film forming step S14 in this case is a step of forming the insulating film 21 so as to cover the base layer 9, the coil 5, the insulating layers 6a, 6b, and the connecting conductors 7, 8 which are obtained by firing. The insulating film 21 is applied as a coating that includes a non-magnetic material such as SiO₂, Al₂O₃, and ZrO₂, for example, by a spray coater. In the case in which the insulating film 21 is a SiO₂ film, the insulating film 21 may, for example, be formed by sputtering.

### Third Variation

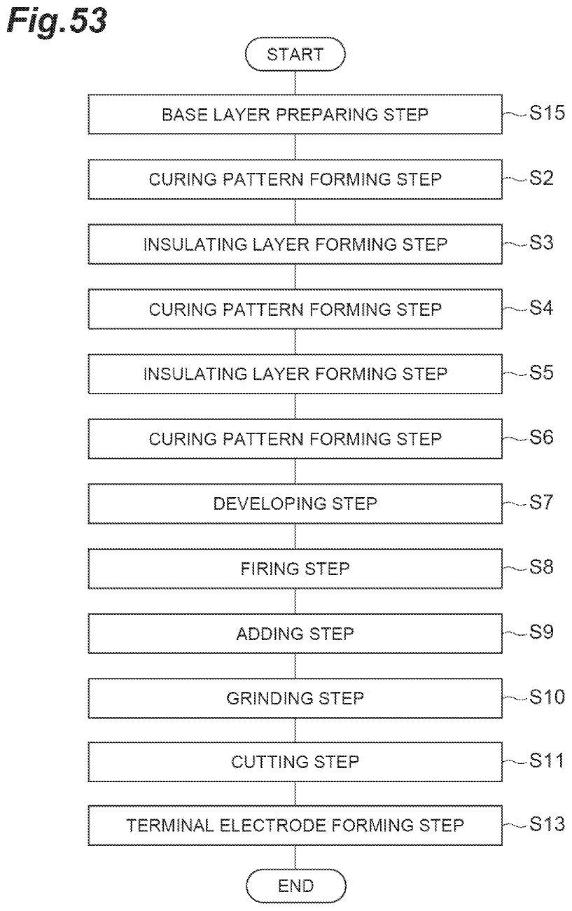

A method for manufacturing a coil component according to a third variation of the first embodiment will be described with reference to FIG. 53. FIG. 53 is a flowchart illustrating a method for manufacturing the coil component according to the third variation of the first embodiment. The main difference between this variation and the first embodiment is that this variation uses the base layer 9 (see FIG. 2) formed in advance as the substrate without using the substrate 11 and the release layer 12 (see FIGS. 4A, 4B, 4C and 4D). As illustrated in FIG. 53, the method for manufacturing the coil component according to this variation includes a base layer preparing step S15 instead of the base layer forming step 51 (see FIG. 3), and does not include the releasing step S12 (see FIG. 3).

In the base layer preparing step S15, the base layer 9 formed in advance is prepared. The base layer 9 to be prepared in the base layer preparing step S15 is, for example, made up of a plurality of integrally formed base layers 9 that are included in a plurality of the coil components 1, and these base layers 9 are to be singulated in the cutting step S11. In the curing pattern forming step S2, the photosensitive conductive paste 14a is directly applied on the base layer 9 prepared in the base layer preparing step S15. In this variation, not only the upper surface of the filler 10 to be the side surface 2c, but also a lower surface of the base layer 9 to be the side surface 2d may be ground in the grinding step S10.

Although the embodiments and variations of the present invention have been described, the present invention is not necessarily limited to the embodiments and variations described above, and various modifications are possible without departing from the gist thereof. The embodiments and variations above may be combined as appropriate.

What is claimed is:

1. A method for manufacturing a coil component comprising an element body, and a coil disposed inside the element body and including a first coil conductor and a second coil conductor having different shapes, the method comprising:
applying a first photosensitive conductive paste on a substrate and exposing the first photosensitive conductive paste to light with a pattern corresponding to the first coil conductor to form a first curing pattern;
after the forming of the first curing pattern, applying a second photosensitive conductive paste on the first photosensitive conductive paste and exposing the second photosensitive conductive paste to light with a pattern corresponding to the second coil conductor to form a second curing pattern;
after the forming of the second curing pattern, developing portions of the first photosensitive conductive paste and the second photosensitive conductive paste that were not exposed; and
after the developing, adding an insulating material on the substrate.

2. The method for manufacturing a coil component according to claim 1,
wherein in the forming of the first curing pattern, application and light exposure of the first photosensitive conductive paste are repeated to form the first curing pattern, and
wherein in the developing, the portions of a plurality of the first photosensitive conductive pastes and the second photosensitive conductive paste that were not exposed are developed.

3. The method for manufacturing a coil component according to claim 1, further comprising forming an insulating layer on the first curing pattern between the forming of the first curing pattern and the forming of the second curing pattern.

4. The method for manufacturing a coil component according to claim 1, further comprising firing the first curing pattern and the second curing pattern between the developing and the adding.

5. The method for manufacturing a coil component according to claim 1, further comprising firing the first curing pattern, the second curing pattern, and the insulating material after the adding.

6. The method for manufacturing a coil component according to claim 1, further comprising forming, on the substrate, a conductive paste to be a terminal electrode to be connected to the coil, before the developing.

7. A method for manufacturing a coil component comprising an element body, and a coil disposed inside the element body and including a coil conductor, the method comprising:
applying a photosensitive conductive paste on a substrate and exposing the photosensitive conductive paste to light with a pattern corresponding to the coil conductor to form a curing pattern;
after the forming of the curing pattern, developing a portion of the photosensitive conductive paste that was not exposed; and
after the developing, adding an insulating material on the substrate,
wherein in the forming of the curing pattern, application and light exposure of the photosensitive conductive paste are repeated to form the curing pattern, and
wherein in the developing, a plurality of the portions of a plurality of the photosensitive conductive pastes that were not exposed are developed.

8. A method for manufacturing a coil component comprising an element body, and a coil disposed inside the element body and including a coil conductor, the method comprising:
applying a photosensitive conductive paste on a substrate and exposing the photosensitive conductive paste to light with a pattern corresponding to the coil conductor to form a curing pattern;
after the forming of the curing pattern, forming an insulating layer on the curing pattern;
after the forming of the insulating layer, developing a portion of the photosensitive conductive paste that was not exposed; and
after the developing, adding an insulating material on the substrate.
